(19) United States
(12) Patent Application Publication
(10) Pub. No.: US 2018/0308396 A1
(43) Pub. Date: Oct. 25, 2018

(54) SIGNAGE SYSTEMS AND MERCHANDISING DISPLAY ASSEMBLIES

(71) Applicant: T.M. SHEA PRODUCTS, INC., Troy, MI (US)

(72) Inventor: Thomas M. SHEA, Troy, MI (US)

(21) Appl. No.: 15/898,954

(22) Filed: Feb. 19, 2018

Related U.S. Application Data
(63) Continuation of application No. 14/921,520, filed on Oct. 23, 2015, now abandoned.

(51) Int. Cl. G09F 7/22; G09F 7/18

(52) U.S. Cl. CPC G09F 7/22; G09F 2007/1856; G09F 2007/1847

(57) ABSTRACT

An information display includes a plurality of panels and a plurality of corresponding pockets. The plurality of are planar panels. Adjacent panels are coupled to one another and oriented at angles relative to one another so as to define a self-supporting structure. Each pocket is associated with one of the panels. Each pocket includes a front side, top and bottom sides, a lateral closed side and a lateral open side, the front side parallel to the associated panel. The top and bottom sides are perpendicular to both the front side and the associated panel. The closed side and the open side are perpendicular to the front side and the panel.

### CROSS-REFERENCE TO RELATED APPLICATION

This application claims priority to U.S. patent application Ser. No. 14/921,520 filed 23 Oct. 2015 which claims the benefit of U.S. Provisional Patent Application No. 62/068,172 filed 24 Oct. 2014, which applications are herein expressly incorporated by reference.

### FIELD

The present teachings generally relate to retail signage systems and merchandising display assemblies.

### DISCUSSION

A multitude of product and product categories crowd the aisles and merchandise displays of retail stores. Signage systems can be used to showcase products or product categories, attract attention and provide guidance to different sections of the store. For example, various signage systems are shown and described in commonly owned U.S. Publication No. 2012/0240436, U.S. Publication No. 2012/0240436 is incorporated by reference as if fully disclosed herein.

Merchandising display assemblies can be used to more effectively position merchandise within the store. For example, one known merchandise display assembly is shown and described in commonly owned U.S. Pat. No. 5,957,422. U.S. Pat. No. 5,957,422 is incorporated by reference as if fully disclosed herein.

While existing signage systems and merchandising display assemblies have proven to be satisfactory for their intended purposes, there remains a need for continuous improvement within the relevant art.

### SUMMARY

In accordance with one particular aspect, the present teachings provide various merchandising display assemblies.

In accordance with another particular aspect, the present teachings provide various signage systems.

In accordance with yet another particular aspect, the present teachings provide various merchandising display brackets.

In accordance with yet another particular aspect, the present teachings provide various merchandising support members.

In accordance with still yet another particular aspect, the present teachings provide various ornamental designs for merchandising display assemblies, merchandising display brackets and signage systems.

Further areas of applicability will become apparent from the description provided herein. It should be understood that the description and specific examples are intended for purposes of illustration only and are not intended to limit the scope of the present disclosure.

### BRIEF DESCRIPTION OF THE DRAWINGS

The present invention will become more fully understood from the detailed description and the accompanying drawings, wherein:

FIG. 1A is a perspective view of an overhead sign system in accordance with the present teachings, the overhead sign system shown operatively associated with a gondola.

FIG. 1B is a rear view thereof, the overhead sign system shown removed from the gondola for purposes of illustration.

FIG. 1C is a front view thereof.

FIG. 1D is a right side view thereof.

FIG. 1E is a left side view thereof.

FIG. 1F is a top view thereof.

FIG. 1G is a bottom view thereof.

FIG. 1H is a view similar to FIG. 1A, illustrating another overhead sign system in accordance with the present teachings, the overhead sign system shown suspending alternative signs.

FIG. 2A is a perspective view of a merchandising display in accordance with the present teachings.

FIG. 2B is a right side view thereof.

FIG. 2C is a left side view thereof.

FIG. 2D is a front view thereof.

FIG. 2E is a rear view thereof.

FIG. 2F is a top view thereof.

FIG. 2G is a bottom view thereof.

FIG. 3A is a perspective view of an adjustable arm assembly in accordance with the present teachings, the adjustable arm assembly shown operatively associated with a sign.

FIG. 3B is a right side view thereof, the sign removed from the gondola for purposes of illustration.

FIG. 3C is a left side view thereof.

FIG. 3D is a front view thereof.

FIG. 3E is a rear view thereof.

FIG. 3F is a top view thereof.

FIG. 3G is a bottom view thereof.

FIG. 3H is a perspective view of the adjustable arm assembly of FIGS. 3A-3G shown operatively associated with a merchandising display.

FIG. 3I is another perspective view of the adjustable arm assembly of FIGS. 3A-3G, the adjustable arm assembly shown operatively associated with another merchandising display.

FIG. 3J is a perspective view of the adjustable arm assembly of FIGS. 3A-3G, the adjustable arm assembly shown operatively associated with another sign.

FIG. 3K is another perspective view of the adjustable arm assembly of FIGS. 3A-3G, the adjustable arm assembly shown operatively associated with another sign.

FIG. 4A is a perspective view of a merchandising display system including a sign holder in accordance with the present teachings, the sign holder shown horizontally oriented and attached to a gondola.

FIG. 4B is a perspective view of the merchandising display system of FIG. 4A, the sign holder shown vertically oriented and attached to a gondola.

FIG. 4C is a right side view of the sign holder of FIGS. 4A and 4B.

FIG. 4D is a left side view of the sign holder of FIGS. 4A and 4B.

FIG. 4E is a front view of the sign holder of FIGS. 4A and 4B.

FIG. 4F is a rear view of the sign holder of FIGS. 4A and 4B.

FIG. 4G is a top view of the sign holder of FIGS. 4A and 4B.

FIG. 4H is a bottom view of the sign holder of FIGS. 4A and 4B.

FIG. 5A is a perspective view of a merchandising display system including another sign holder in accordance with the present teachings, the sign holder shown horizontally oriented and adapted for support on a horizontal surface.

FIG. 5B is a perspective view of the sign holder of FIG. 5A, the sign holder shown suspended from a gondola.

FIG. 5C is another perspective view of the sign holder of FIG. 5A, the sign holder shown alternatively suspended from a gondola.

FIG. 5D is a right side view of the sign holder of FIGS. 5A-5C.

FIG. 5E is a left side view of the sign holder of FIGS. 5A-5C.

FIG. 5F is a front view of the sign holder of FIGS. 5A-5C.

FIG. 5G is a rear view of the sign holder of FIGS. 5A-5C.

FIG. 5H is a top view of the sign holder of FIGS. 5A-5C.

FIG. 5I is a bottom view of the sign holder of 5A-5C.

FIG. 6A is a perspective view of a coupling member for a signage or merchandising display system in accordance with the present teachings.

FIG. 6B is a front view of the coupling member of FIG. 6A.

FIG. 6C is a rear view of the coupling member of FIG. 6A.

FIG. 6D is right side view of the coupling member of FIG. 6A.

FIG. 6E is left side view of the coupling member of FIG. 6A.

FIG. 6F is a top view of the coupling member of FIG. 6A.

FIG. 6G is a bottom view of the coupling member of FIG. 6A.

FIG. 6H is a perspective view of the coupling member of FIG. 6A, the coupling member shown coupling a suspension arm with a merchandise display panel.

FIG. 6I is a perspective view of the coupling member of FIG. 6A, the coupling member shown coupling a bracket with a sign.

FIG. 7A is a perspective view of another merchandising display in accordance with the present teachings.

FIG. 7B is a front view of the merchandising display of FIG. 7A, it being understood that the opposite side is a mirror image thereof.

FIG. 7C is a left side view of the merchandising display of FIG. 7A.

FIG. 7D is a top view of the merchandising display of FIG. 7A.

FIG. 7E is a bottom view of the merchandising display of FIG. 7A.

FIG. 8A is a perspective view of an extension assembly in accordance with the teachings of the present invention, the extension assembly shown in a first orientation.

FIG. 8B is another perspective view of the extension assembly of FIG. 8A, the extension assembly shown in a second orientation.

FIG. 8C is a right side view of the extension assembly of FIG. 8A.

FIG. 8D is a left side view of the extension assembly of FIG. 8A.

FIG. 8E is a front view of the extension assembly of FIG. 8A.

FIG. 8F is a rear view of the extension assembly of FIG. 8A.

FIG. 8G is a top view of the extension assembly of FIG. 8A.

FIG. 8H is a bottom view of the extension assembly of FIG. 8A.

FIG. 8I is an environmental view illustrating a pair of extension assemblies of FIG. 8A operatively associated with signage, the extension assemblies further shown attached to uprights of a gondola.

FIG. 8J is an environmental view illustrating a pair of risers of the extension assemblies of FIG. 8A operatively associated with signage, the risers shown attached to uprights of a gondola.

FIG. 9A is a perspective view of a merchandise display bin in accordance with the present teachings.

FIG. 9B is a right side view of the merchandise display bin of FIG. 9A, it being understood that the left side view is a mirror image thereof.

FIG. 9C is a front view of the merchandise display bin of FIG. 9A, it being understood that the rear view is a mirror image thereof.

FIG. 9D is a top view of the merchandise display bin of FIG. 9A.

FIG. 9E is a bottom view of the merchandise display bin of FIG. 9A.

FIG. 9F is a perspective view of reinforcing member of the merchandise display bin of FIGS. 9A-9E.

FIG. 9G is a perspective view of an assembly step for the merchandise display bin of FIGS. 9A-9E.

FIG. 9H is a perspective view of an alternative assembly step for the merchandise display bin of FIGS. 9A-9E.

FIG. 10A is a perspective view of another signage system in accordance with the present teachings, the signage system shown operatively extending from a gondola.

FIG. 10B is a perspective view of an extender arm of FIG. 10A.

FIG. 10C is a right side view of the extender arm of FIG. 10A.

FIG. 10D is a left side view of the extender arm of FIG. 10A.

FIG. 10E is a front view of the extender arm of FIG. 10A.

FIG. 10F is a rear view of the extender arm of FIG. 10A.

FIG. 10G is a top view of the extender arm of FIG. 10A.

FIG. 10H is a bottom view of the extender arm of FIG. 10A.

FIG. 11 is a perspective view of another merchandising display in accordance with the present teachings.

FIG. 12 is a perspective view of another merchandising display in accordance with the present teachings.

FIG. 13A is perspective view of a sign holder operatively associated with a pair of mounting brackets in accordance with the present teachings.

FIG. 13B is a perspective view of one of the mounting brackets of FIG. 13A.

FIG. 13C is a right side view of the mounting bracket of FIG. 13B.

FIG. 13D is a left side view of the mounting bracket of FIG. 13B.

FIG. 13E is a front side view of the mounting bracket of FIG. 13B.

FIG. 13F is a rear side view of the mounting bracket of FIG. 13B.

FIG. 13G is a top view of the mounting bracket of FIG. 13B.

FIG. 13H is a bottom view of the mounting bracket of FIG. 13B.

FIG. 14A is a perspective view of a flexible coupling member of a signage system, the flexible coupling member shown when the signage system is in the first position.

FIG. 14B is view similar to FIG. 14A, illustrating the flexible coupling member when the signage system is in the second position.

FIG. 14C is a perspective view of another signage system in accordance with the present teachings.

FIG. 14D is a perspective view of another signage system in accordance with the present teachings.

FIG. 15A is a perspective view of an extender arm in accordance with a further embodiment of the present teachings.

FIG. 15B is a right side view of the extender arm of FIG. 15A.

FIG. 15C is a left side view of the extender arm of FIG. 15A.

FIG. 15D is a front view of the extender arm of FIG. 15A.

FIG. 15E is a rear view of the extender arm of FIG. 15A.

FIG. 15F is a top view of the extender arm of FIG. 15A.

FIG. 15G is a bottom view of the extender arm of FIG. 15A.

FIG. 15H is an environmental view of the extender arm of FIG. 15A-15G illustrating the extender arm coupling a sign holder with an upright of a gondola.

FIG. 15I is an environmental view of the extender arm of FIG. 15A-15G illustrating the extender arm coupling a sign holder with a merchandising display.

FIG. 15J is an environmental view of the extender arm of FIG. 15A-15G illustrating the extender arm coupling a sign holder with another merchandising display.

FIG. 16A is a perspective view of an another extender arm in accordance with a further embodiment of the present teachings.

FIG. 16B is a right side view of the extender arm of FIG. 15A.

FIG. 16C is a left side view of the extender arm of FIG. 15A.

FIG. 16D is a front view of the extender arm of FIG. 15A.

FIG. 16E is a rear view of the extender arm of FIG. 15A.

FIG. 16F is a top view of the extender arm of FIG. 15A.

FIG. 16G is a bottom view of the extender arm of FIG. 15A.

FIG. 17A is a perspective view of another coupling member for a signage or merchandising display system in accordance with the present teachings.

FIG. 17B is a front view of the coupling member of FIG. 6A.

FIG. 17C is a rear view of the coupling member of FIG. 6A.

FIG. 17D is right side view of the coupling member of FIG. 6A.

FIG. 17E is left side view of the coupling member of FIG. 6A.

FIG. 17F is a top view of the coupling member of FIG. 6A.

FIG. 17G is a bottom view of the coupling member of FIG. 6A.

FIG. 17H is a perspective view of the coupling member of FIG. 17A, the coupling member shown coupling a suspension arm with a merchandise display panel.

FIG. 17I is a perspective view of the coupling member of FIG. 17A, the coupling member shown coupling a bracket with a sign.

FIG. 18 is a perspective view of another adjustable arm assembly in accordance with the present teachings, the adjustable arm assembly shown operatively associated with a merchandising display.

FIG. 19A is a perspective view of another signage system in accordance with the present teachings.

FIG. 19B is a perspective view of the signage system of FIG. 19A, the signage system shown exploded.

FIG. 19C is a perspective view of another signage system in accordance with the present teachings.

FIG. 19D is a perspective view of the signage system of FIG. 19C, the signage system shown exploded.

FIG. 19E is a right side view of the signage system of FIG. 19C.

FIG. 19F is a left side view of the signage system of FIG. 19C.

FIG. 19G is a front view of the signage system of FIG. 19C.

FIG. 19H is a rear view of the signage system of FIG. 19C.

FIG. 19I is a top view of the signage system of FIG. 19C.

FIG. 19J is a bottom view of the signage system of FIG. 19C.

It will be understood that the various embodiments shown throughout the application are drawn to scale.

### DESCRIPTION OF VARIOUS ASPECTS

The following description is merely exemplary in nature and is in no way intended to limit the invention, its application, or uses.

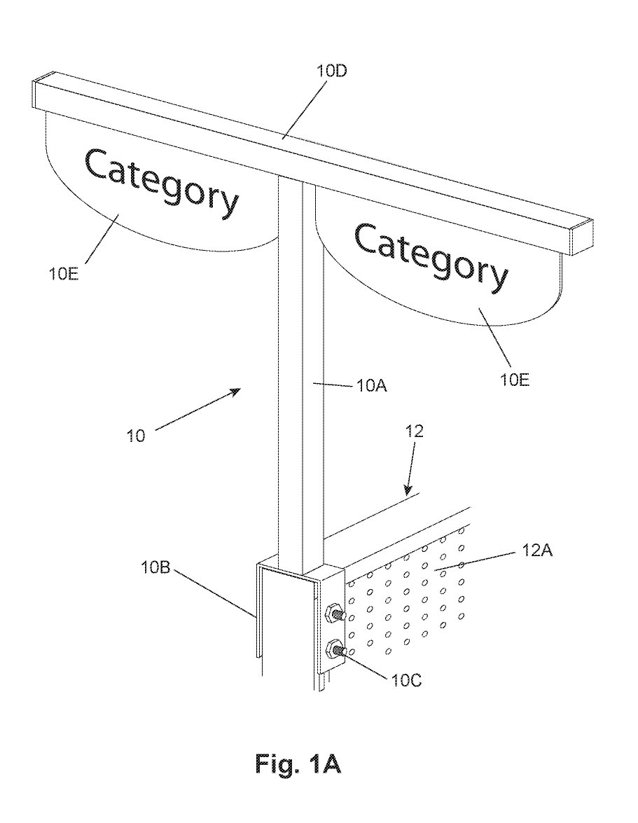

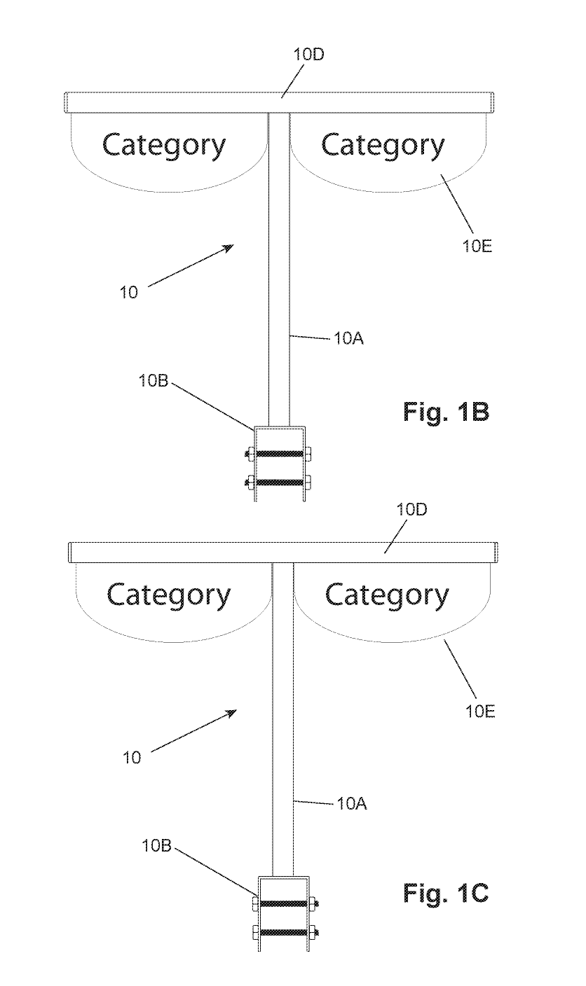

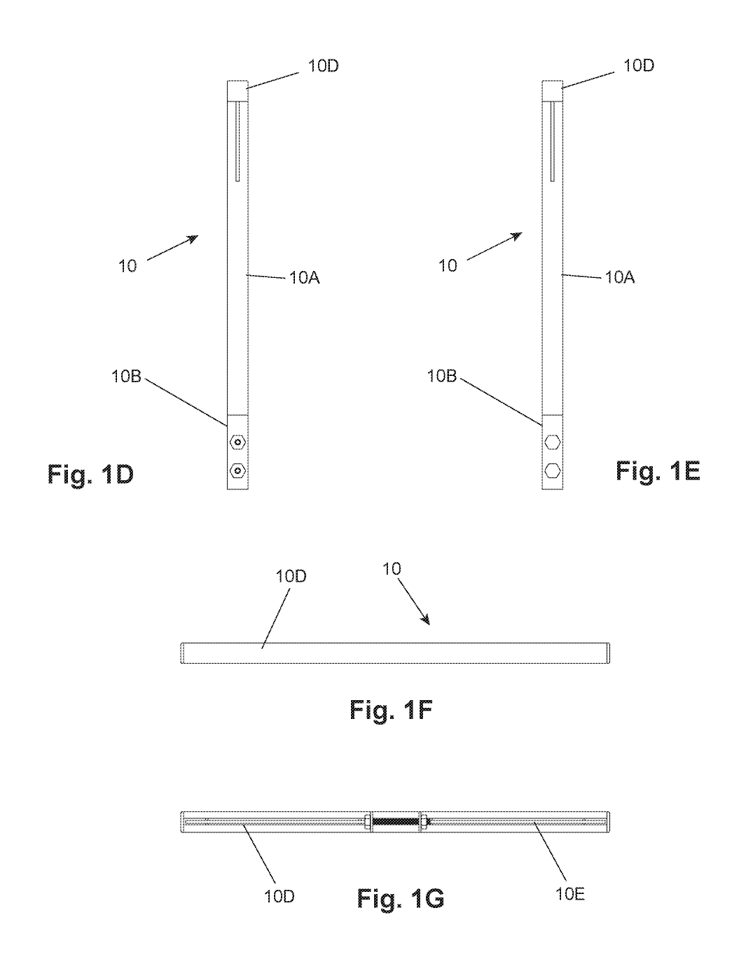

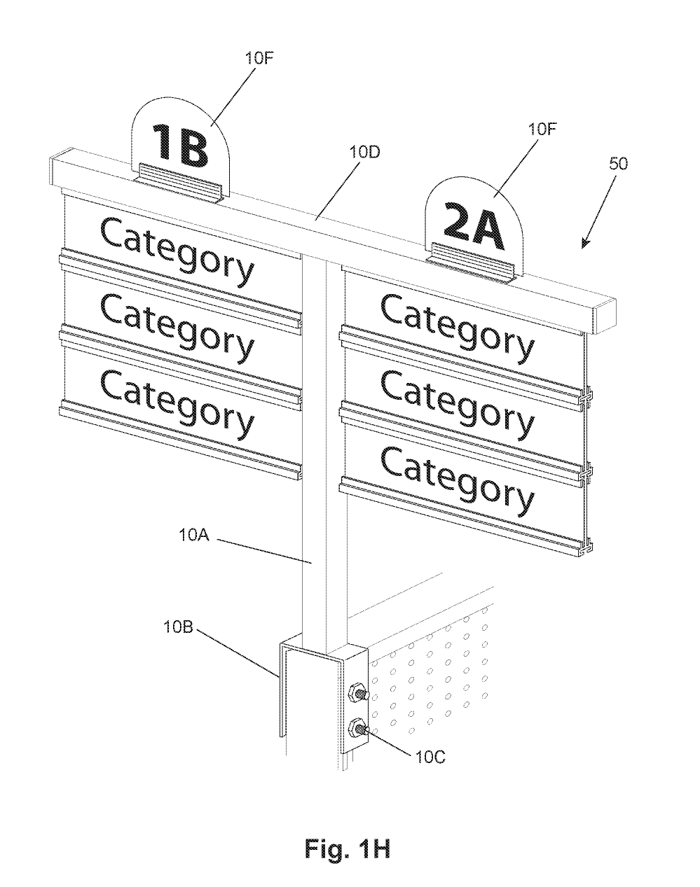

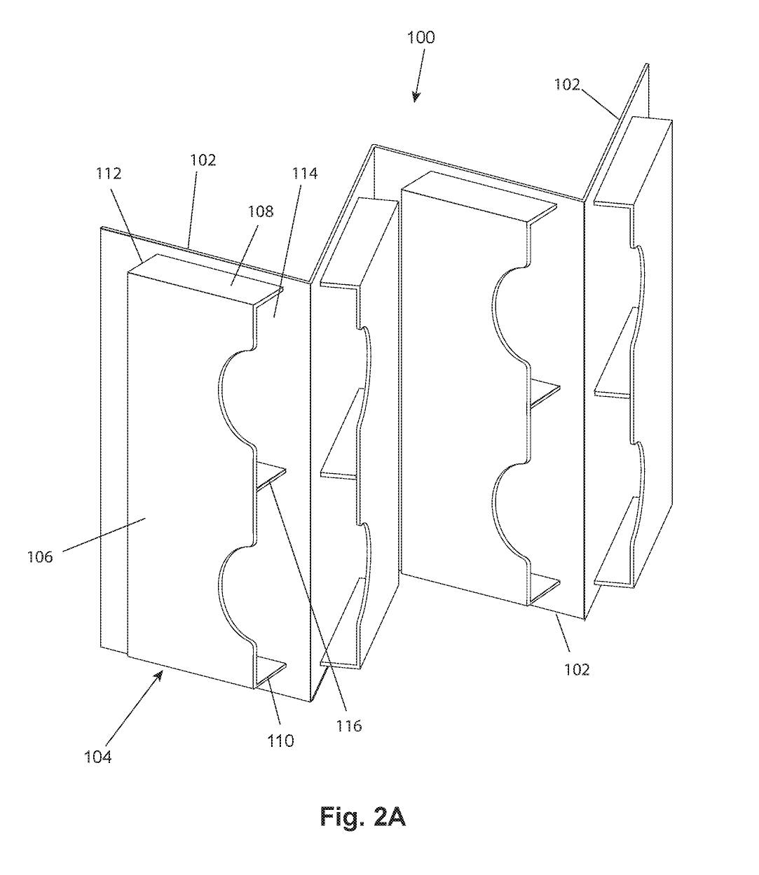

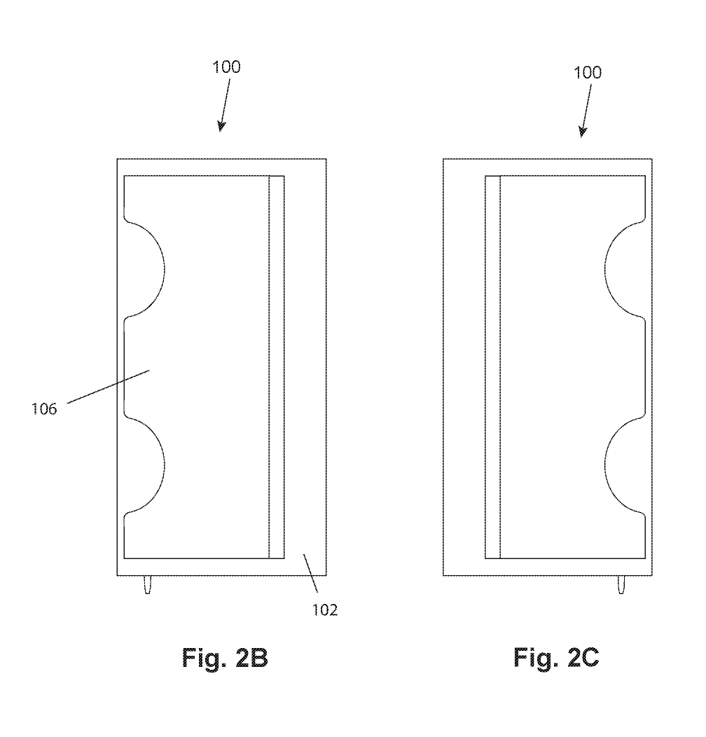

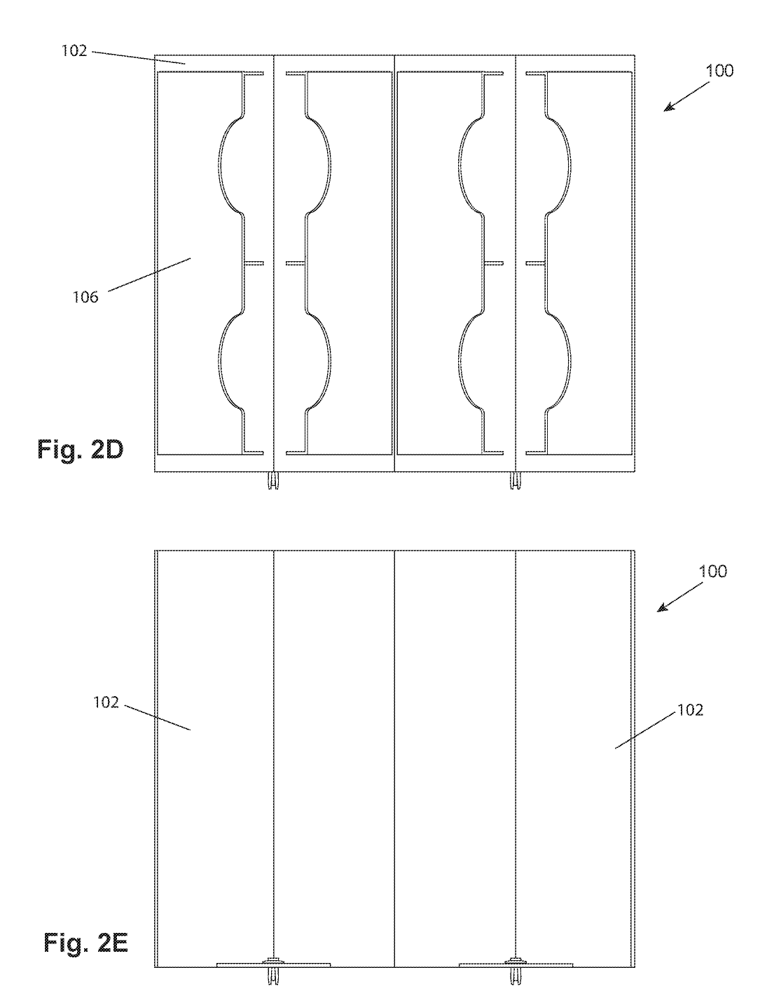

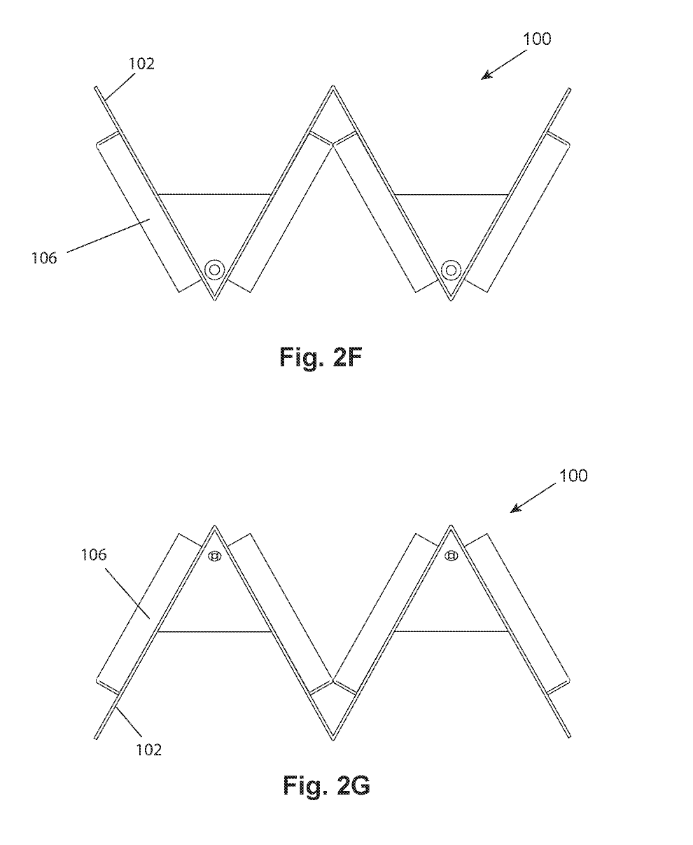

With initial reference to FIGS. 1A through 1G, an overhead sign system in accordance with the present teachings is illustrated and generally identified at reference character 10. The overhead sign system 10 is shown operatively associated with a gondola 12. Insofar as the present teachings are concerned, the gondola will be understood to be conventional in construction.

The system 10 may include a vertically extending tubular arm 10A. The vertically extending tubular arm 10A may have a generally rectangular cross section and may be secured at lower end to a C-shaped member 10B for engaging an upper end of a pegboard wall 12A of the gondola 12. The C-shaped member 10B may be secured with fasteners 10C. The vertically extending tubular arm 10A may be welded or otherwise permanently or removably secured to the C-shaped member. An upper end of the vertically extending tubular arm 10A may be secured to a generally horizontal arm 10D. The arms 10A and 10D may be welded or otherwise secured to one another. One or more signs 10E may be suspended from the horizontal arm 10D. The arms 10A and 10D may be oriented in a plane generally perpendicular to the gondola 12.

Turning to FIG. 1H, another overhead sign system in accordance with the present teachings is illustrated and generally identified at reference character 50. The overhead sign system 50 is similar to the overhead sign system 10 except that it suspends alternative signs. Like reference characters are used to identify similar elements. Additionally, the system 50 includes aisle markers 10F on the horizontal arm 10D.

Turning to 2A to 2G, a merchandising display in accordance with the present teachings is illustrated and generally identified at reference character 100. The display 100 is particularly adapted for the display of PSE cards, for example. The display 100 may be uniformly constructed of a clear plastic material and adapted to sit on a horizontal surface, for example. Where it is desired to secure the display to a gondola or other structure, rivets or other conventional fasteners may be used.

In the embodiment illustrated, the display is shown to include a plurality of panels 102. The panels 102 may be planar and shape and may be oriented at angles relative to one another so as to define a self-supporting structure. Each panel 102 is associated with a pocket 104. The pocket 104 may include a front side 106 parallel to the associated panel 102, top and bottom sides 108 and 110 perpendicular to both the front side 104 and the panel 102. Each pocket 104 may additionally include a closed side 112 perpendicular to the front side 106 and the panel 102 and an open side 114 perpendicular to the front side and the panel. The front sides 106 may include cut-out scallop portions to provide access to cards in the pocket 104.

Each pocket 104 may be associated with a horizontal member 116 which horizontally bisects the opening defined between the pockets 104 and associated panels 112. Cards for display may be inserted into this opening and supported on either an upper side of the horizontal member 116 or an upper side of the bottom side 110. The display 100 may be unitarily formed of a clear material such as an acrylic, for example. Other well-known materials may be alternatively used.

In the embodiment illustrated, the display 100 includes a single horizontal tier. It will be understood, however, that the display 100 may be constructed within the scope of the present teachings to include a plurality of horizontal tiers.

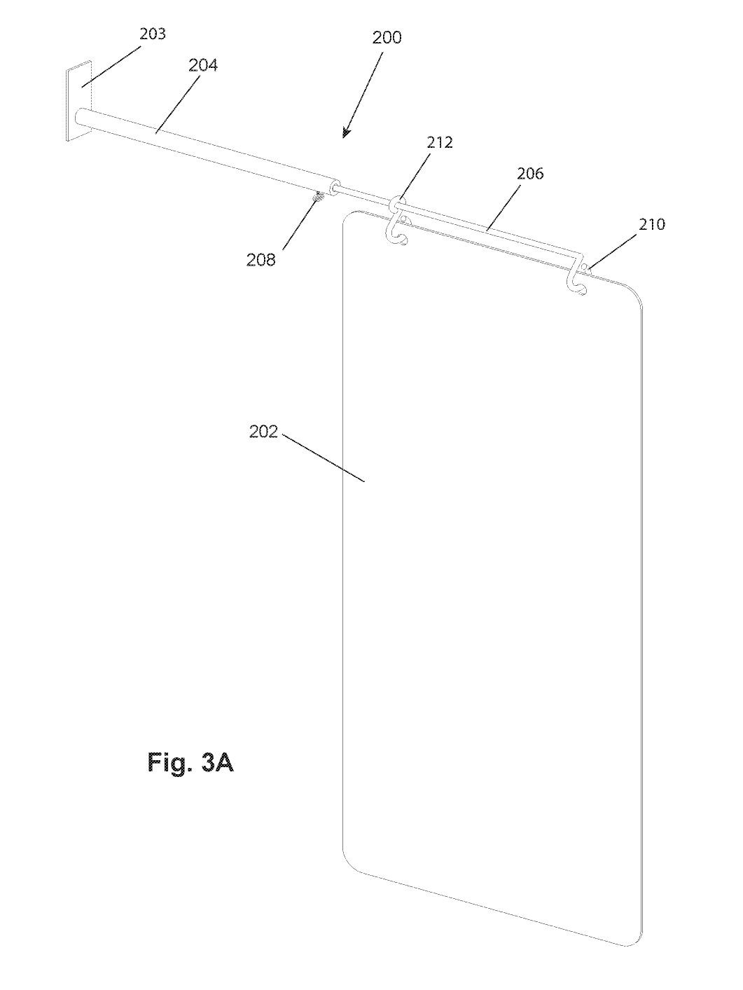

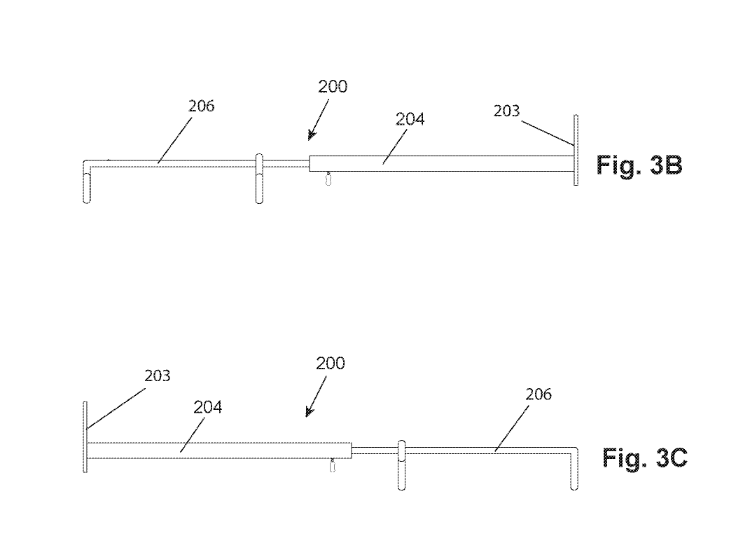

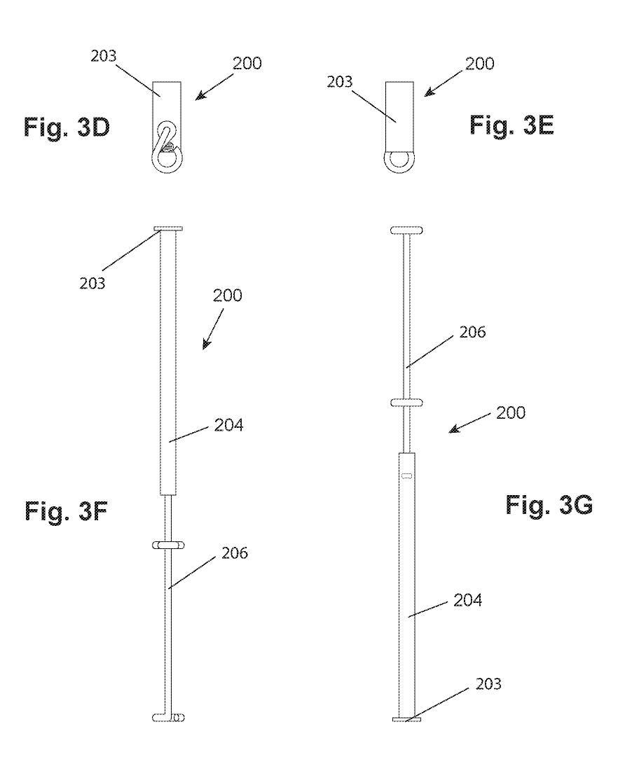

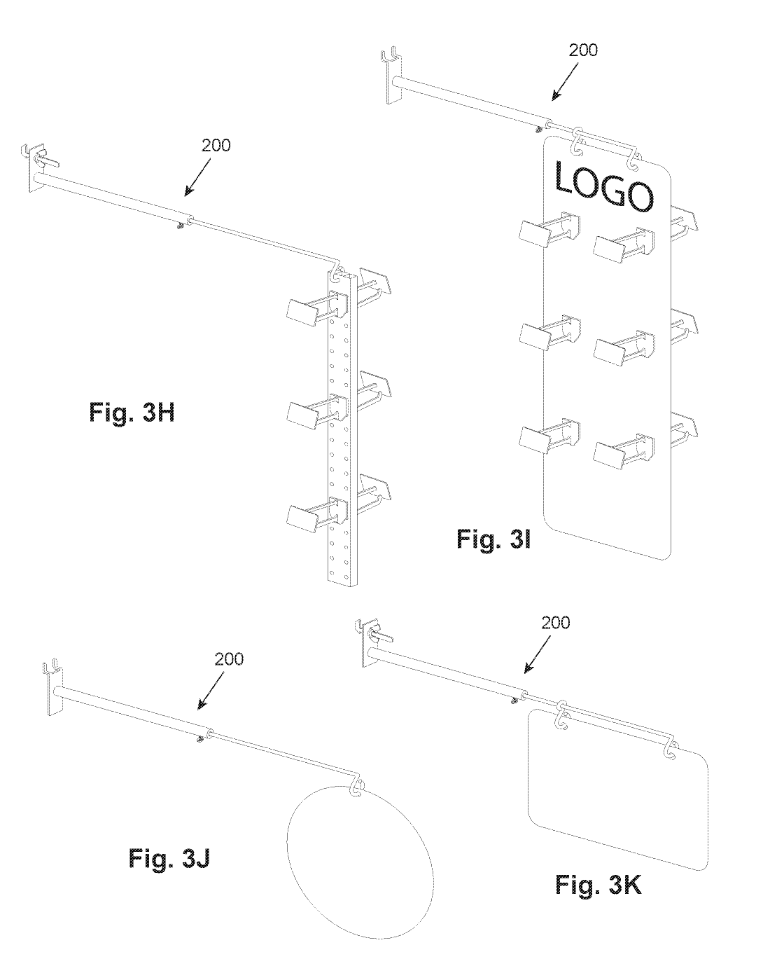

Turning to 3A to 3G, an adjustable arm assembly in accordance with the present teachings is illustrated and generally identified at reference character 200. FIG. 3A illustrates the adjustable arm assembly operatively associated with a first sign 202. The assembly 200 is illustrated to include a mounting member 203, an arm or tube 204, and an adjustable wire arm 206. A set screw 208 may fix the telescopic orientation between the tube 204 and a wire arm 206. A distal end of the wire arm 206 may be formed to include a loop 210. A similarly shaped hanger 212 may be slidably provided along the length of the wire arm.

With reference to FIG. 3H, the adjustable arm assembly of FIGS. 3A-3G is shown operatively associated with a first merchandise display. The mounting member is particularly adapted to mount to an upright of a gondola.

With reference to FIG. 3I, the adjustable arm assembly of FIGS. 3A-3G is shown operatively associated with a second merchandise display. The mounting member is particularly adapted to mount to a peg board.

With reference to FIG. 3J, the adjustable arm assembly of FIGS. 3A-3G is shown operatively associated with a second sign. Again, the mounting member is particularly adapted to mount to a peg board.

With reference to FIG. 3K, the adjustable arm assembly of FIGS. 3A-3G is shown operatively associated with a third sign. Again, the mounting member is particularly adapted to mount to an upright of a gondola.

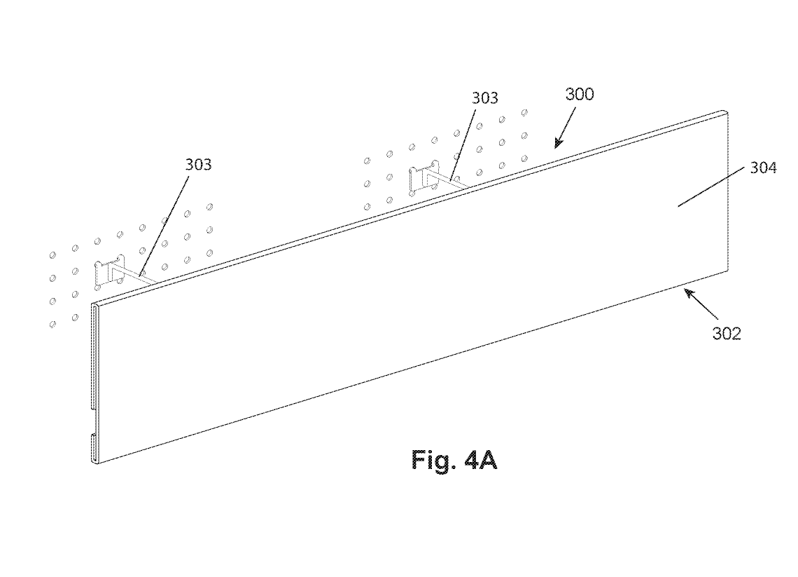

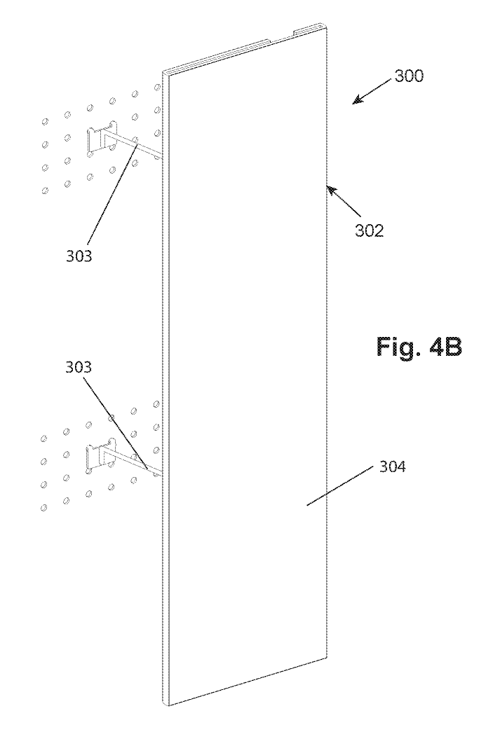

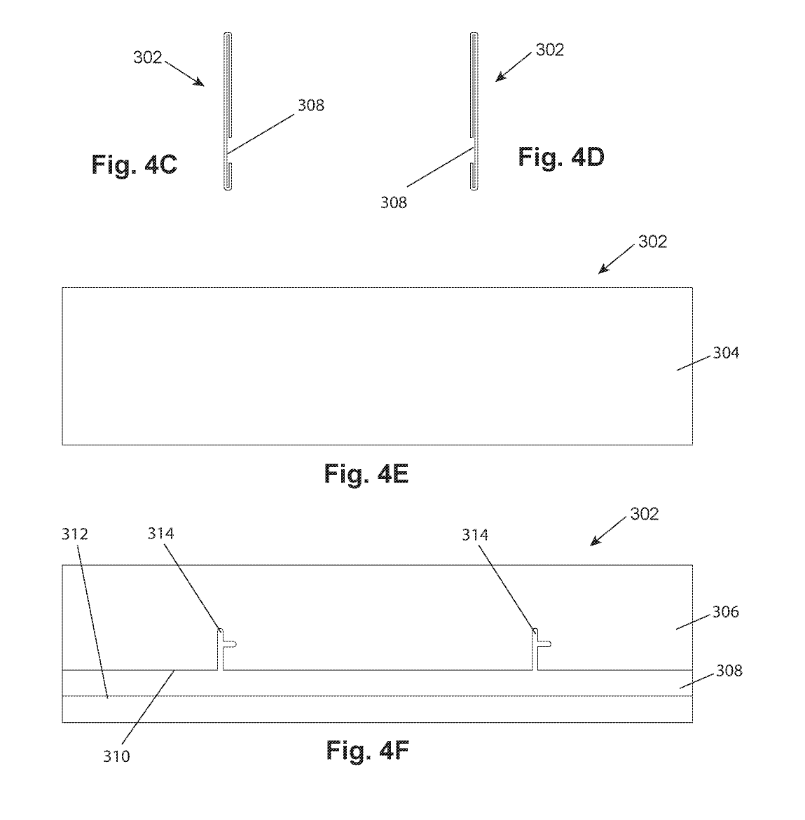

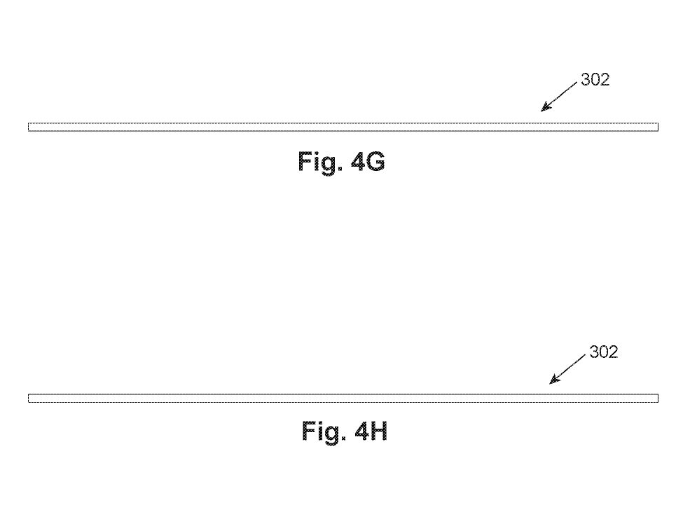

Turning to FIGS. 4A through 4H, a merchandising display system in accordance with the present teachings is shown and generally identified at reference character 300. The merchandising display system generally includes a sign holder 302. In FIG. 4A, the sign holder 302 is shown horizontally oriented and attached to a gondola 12 with a pair of mounting arms 303. In FIG. 4B, the sign holder 302 is shown vertically oriented and attached to a gondola 12. As illustrated, the sign holder 302 may be unitarily constructed of a clear acrylic material.

The sign holder 302 includes a front side 304 and a rear side 306. At the rear side 306, a longitudinally extending gap 308 defined between first and second edges 310 and 312. A plurality of generally T-shaped slots 314 are defined at the rear side 306. A first arm of each slot communicates with the gap 310 between the edges 310 and 312. The mounting arms 303 may be received within the slots 314. A generally planar plate carried at a distal end of each arm is received within a space between the front side and rear side of the sign holder 302. A sign (not shown) may be located between the front and rear sides 304 and 306 and be visible through the front side 304.

It will be understood that the sign holder 302 is formed of a single sheet of material that is folded along an upper edge and a lower edge. The material overlaps to form the rear side 306. As such, the material of the sign holder may continuously transition from the front side 304 to the rear side 306. For example, this transition may be through rounded edges from the front side 304 to the rear side 306.

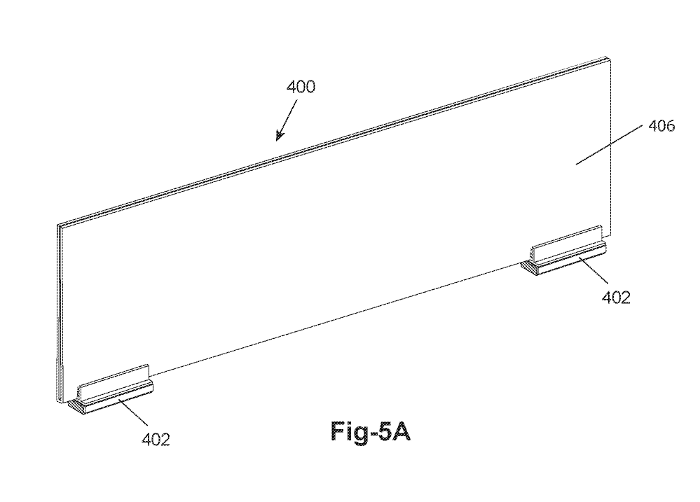

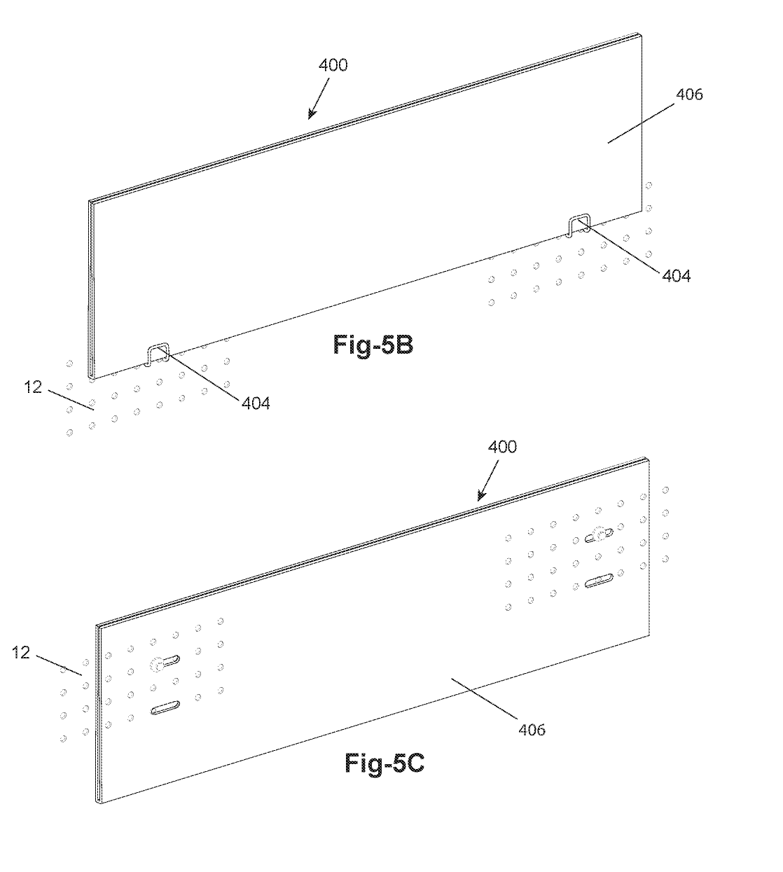

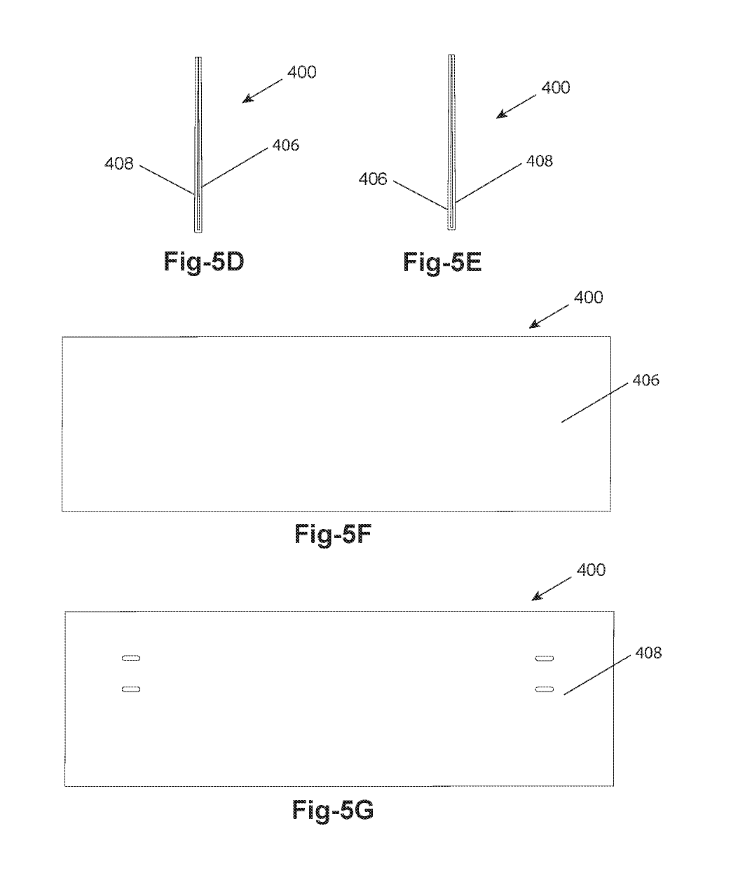

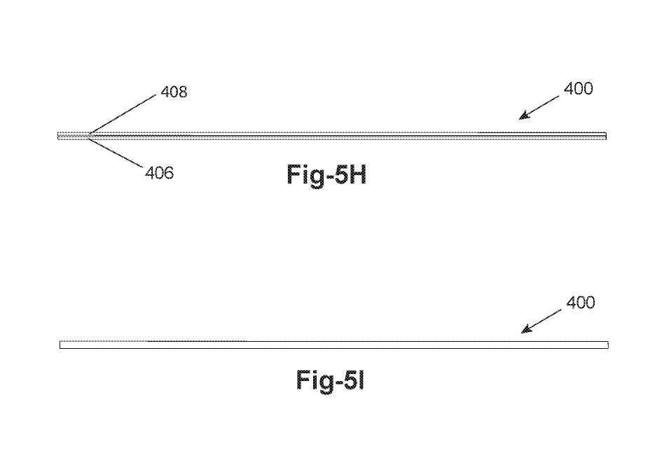

Turning to FIGS. 5A-5I, another sign holder in accordance with the present teachings is illustrated and generally identified at reference character 400. Again, the sign holder 400 may be constructed of a clear acrylic material. In FIG. 5A, the sign holder is shown horizontally oriented and adapted for support on a horizontal surface with a pair of mounting members 402. In FIG. 5B, the sign holder 400 is shown suspended from a gondola 12 with a pair of mounting arms 404. In FIG. 5C, the sign holder is shown alternatively suspended from a gondola 12. The sign holder 400 includes front and rear overlapping sides 406 and 408. A sign (not shown) may be located between the two overlapping sides.

As with the sign holder 302, the sign holder 400 may be formed of a single sheet of material. The sign holder 400 may be folded along an lower edge. The material overlaps to form the rear side 408. As such, the material of the sign holder 400 may continuously transition from the front side 406 to the rear side 408. For example, this transition may be through a rounded lower edge from the front side 406 to the rear side 408.

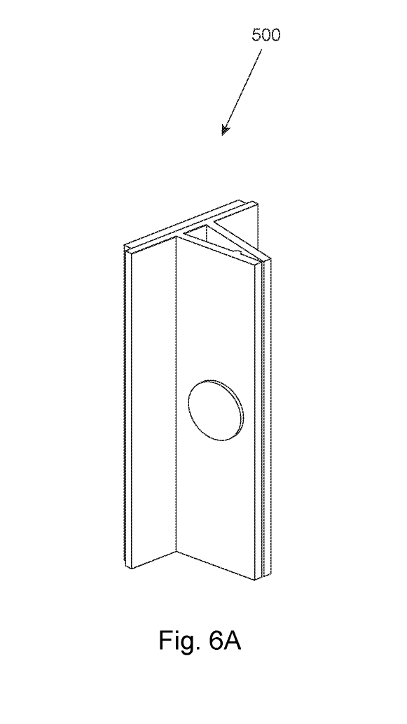

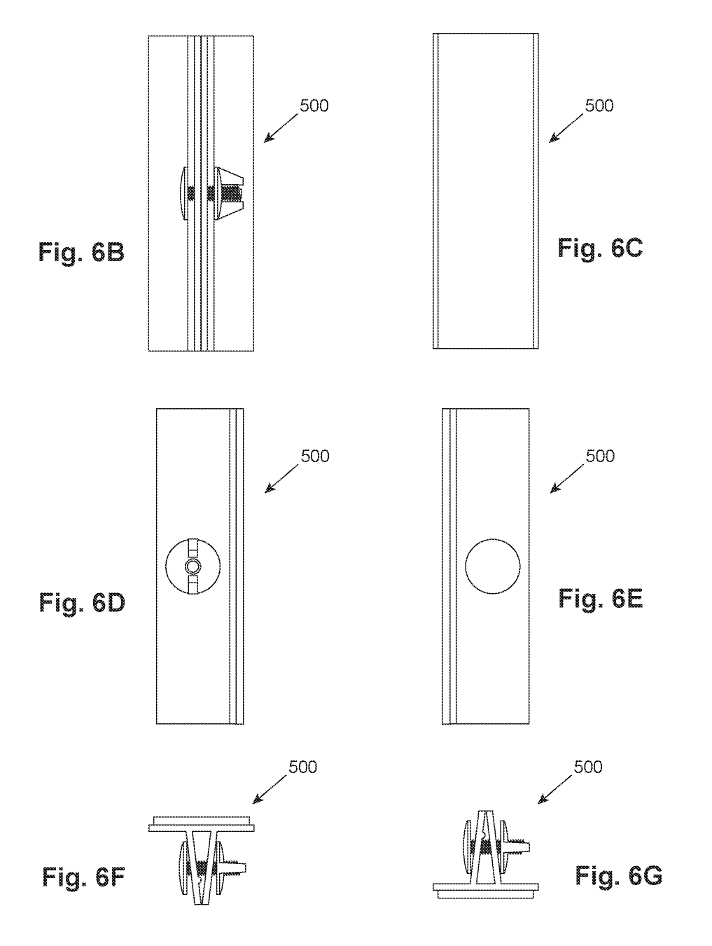

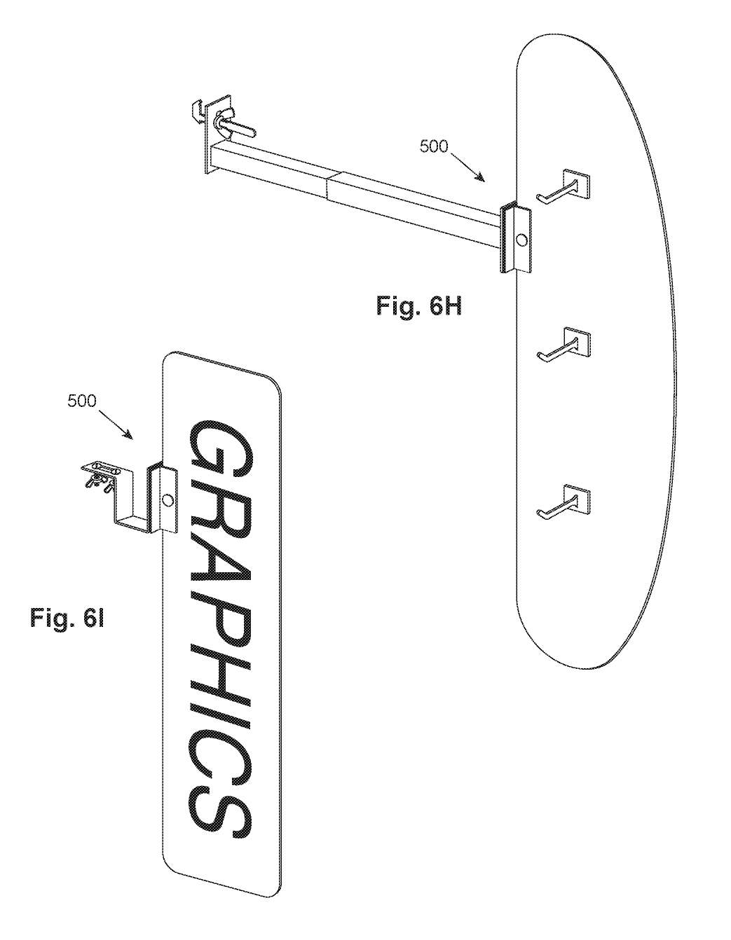

Turning to FIGS. 6A through 6I, a coupling member for a signage or merchandising display system in accordance with the present teachings is illustrated and generally identified at reference character 500. In FIG. 6H, the coupling member is shown coupling a suspension arm with a merchandise display panel. In FIG. 6I, the coupling member is shown coupling a bracket with a sign. The coupling member 500 may be formed to include an opening for a fastener. The coupling member 500 may include a mounting portion and a pair of jaws extending from the mounting portion. The jaws may deflect relative to the mounting portion.

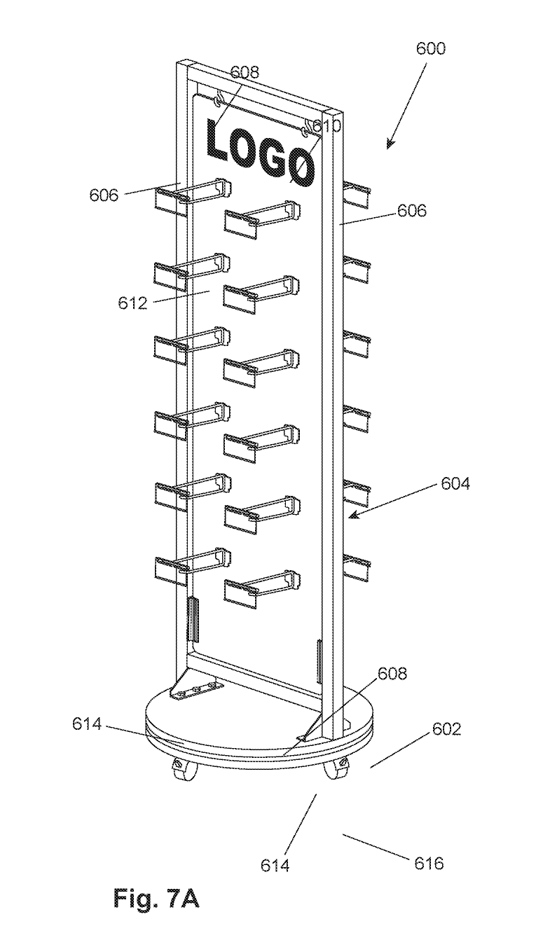

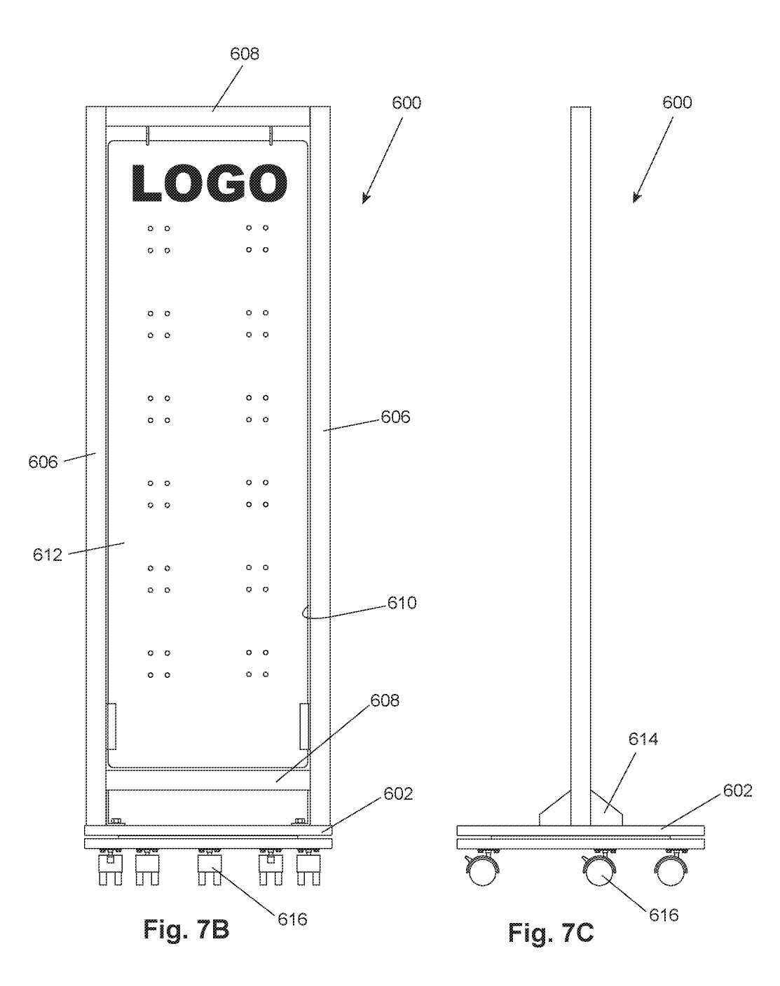

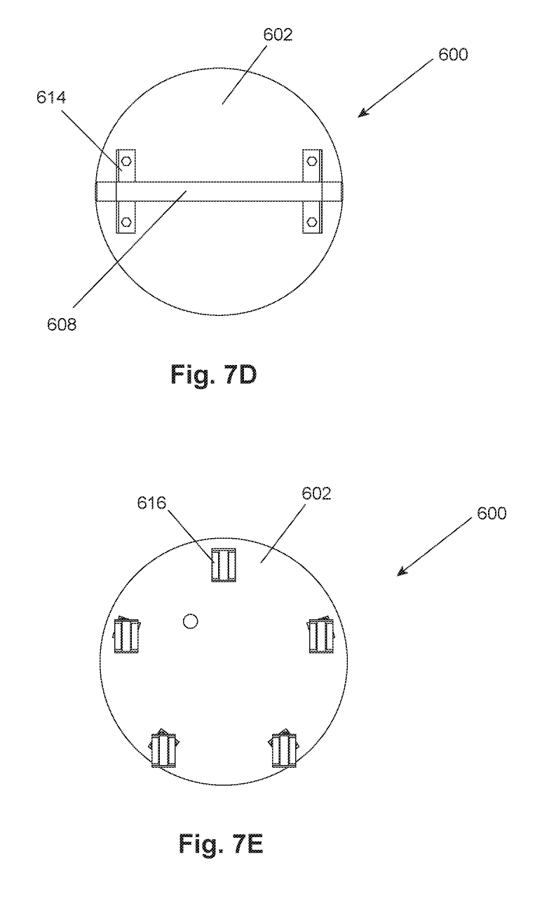

Turning to FIGS. 7A-7E, a merchandising display system in accordance with the present teachings is illustrate and generally identified at reference character 600. The system 600 is generally shown to include a base 602 and an upwardly extending frame 604. The frame 604 may include a pair of upwardly extending members 606 and a pair of laterally extending members 608. As illustrated, the upwardly and laterally extending members 606 and 608 may be generally rectangular in cross section. The upwardly and laterally extending members 606 and 608 may cooperate to define a generally rectangular opening 610. A display panel 612 may be suspended in the opening 610. The frame 604 may be mounted to the base 602 with brackets 614. The base 602 may be generally circular. A plurality of casters 616 may be carried by the base 602.

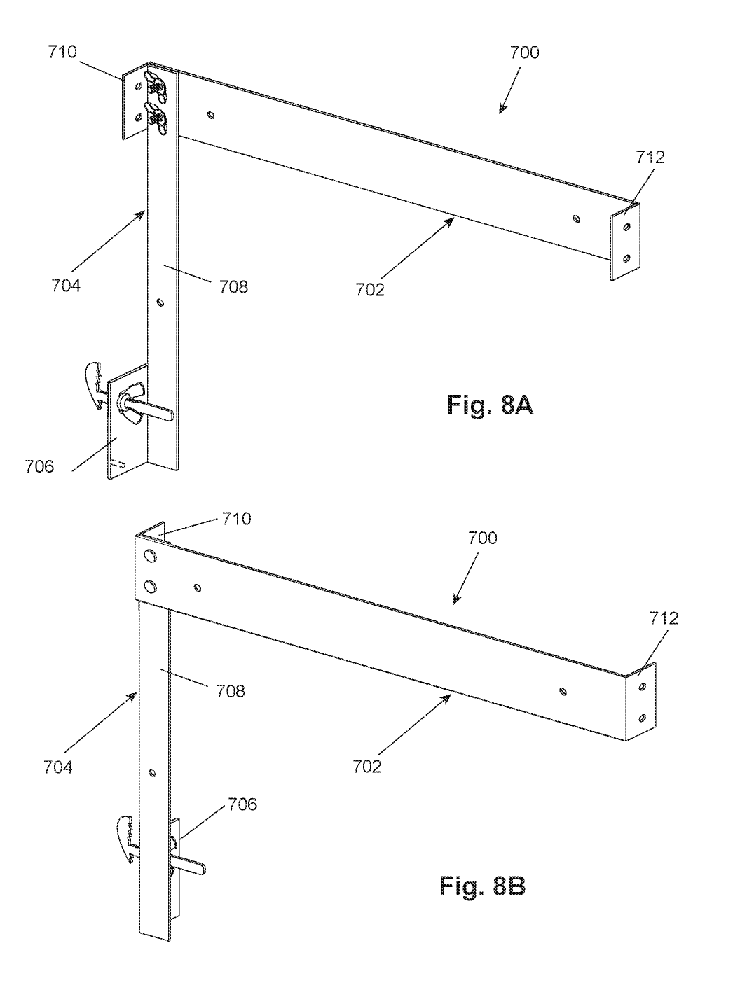

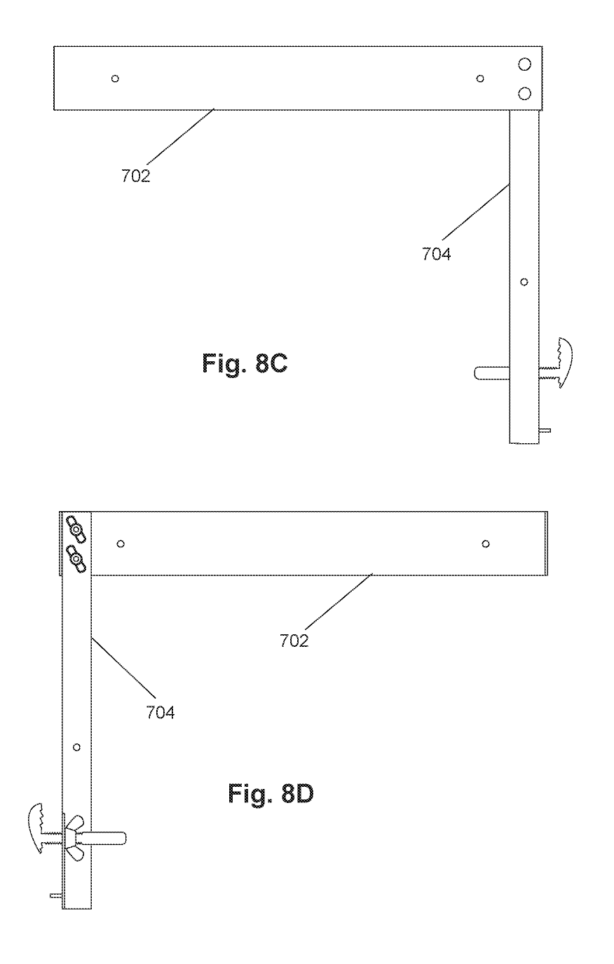

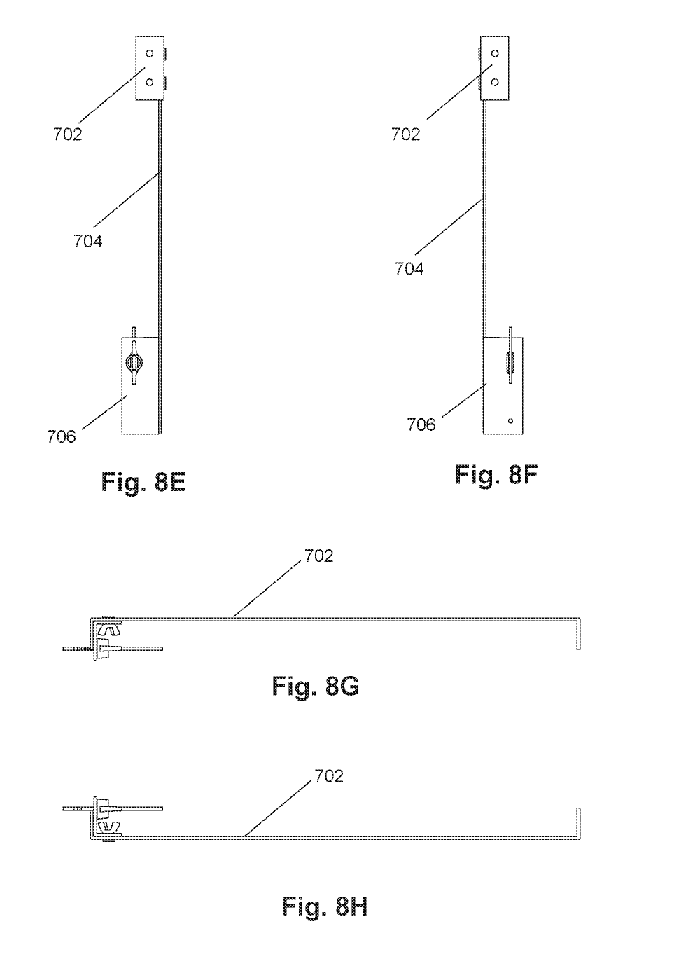

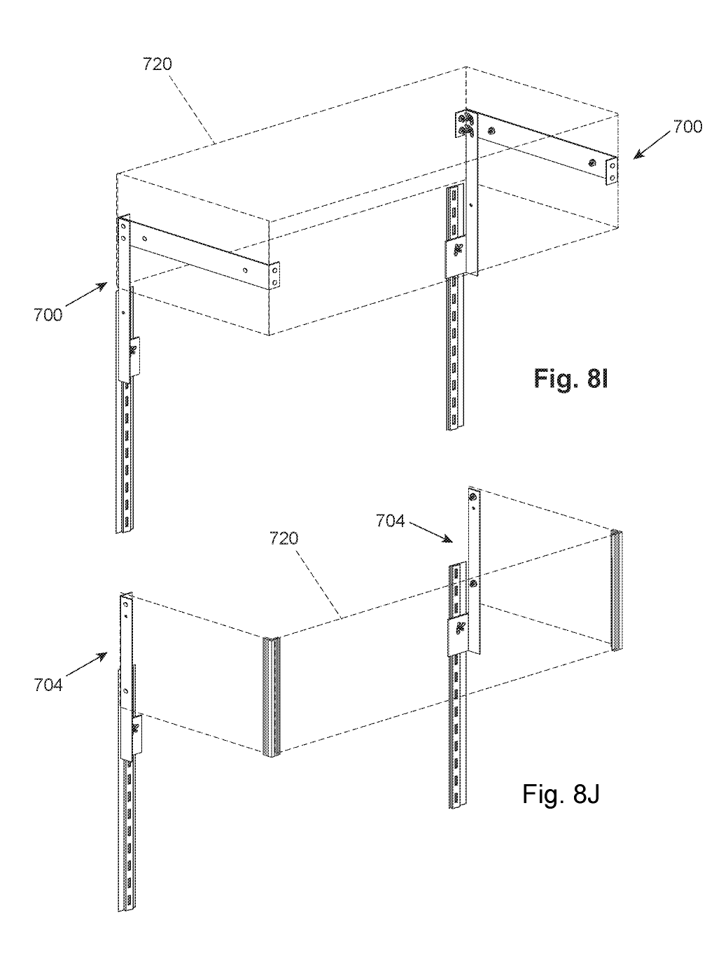

Turning to FIGS. 8A-8H, an extension assembly in accordance with the teachings of the present invention is illustrated and generally identified at reference character 700. In FIG. 8A, the extension assembly 700 is shown in a first orientation. In FIG. 8B, extension assembly 700 is shown in a second orientation. The extension assembly 700 is generally shown to include an extender 702 and a riser 704. The extender 702 will be understood to be common between FIGS. 8A and 8B. The risers 704 will be understood to be mirror images of one another. In this regard, a mounting flange 706 of the riser 704 of FIG. 8A extends from an upright member 708 in a leftward direction. The mounting flange 706 of the riser 704 of FIG. 8B extends in a rightward direction.

The extender 702 includes a first mounting portion or return 710 at a proximal end and a second mounting portion or return 712 at a distal end. The riser 704 may include the mounting portion 706 at a lower end and may be releasably or fixedly secured at an upper end to the extender 702. As illustrated, the mounting portion 706 of the riser 704 is particularly adapted to engage an upright of a gondola 12 with conventional hardware.

In FIG. 8I, a pair of extension assemblies 700 of FIG. 8A-8H are shown operatively associated with signage 720 (shown in dashed lines). The extension assemblies 700 are further shown attached to uprights of a gondola 12. In FIG. 8J, a pair of risers 704 of the extension assemblies 700 of FIGS. 8A and 8B operatively associated with signage, the risers 704 shown attached to uprights of a gondola 12.

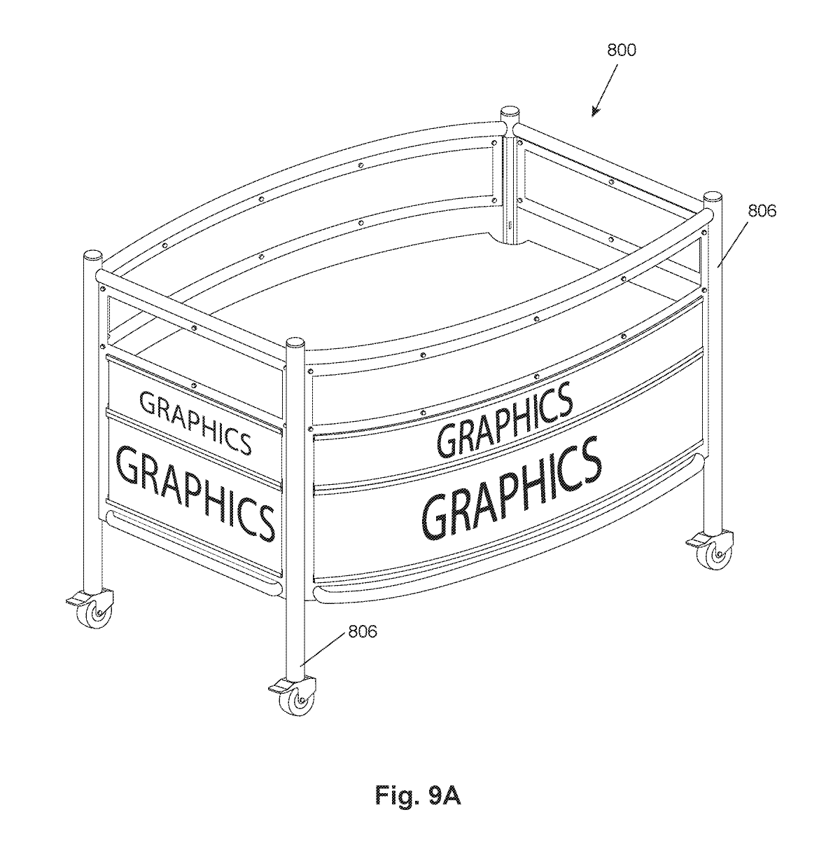

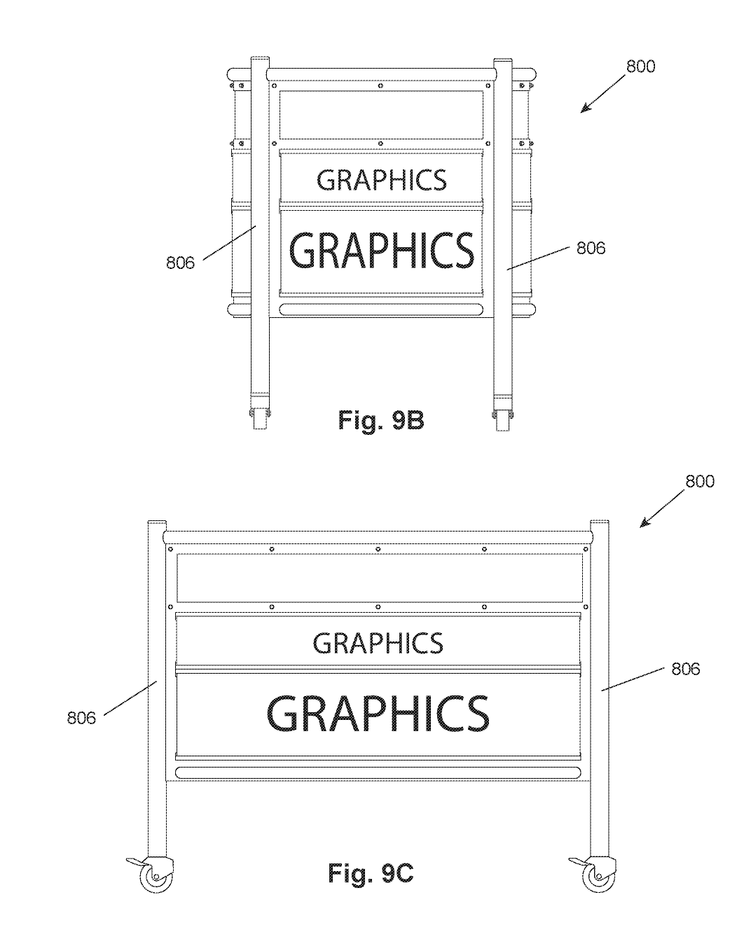

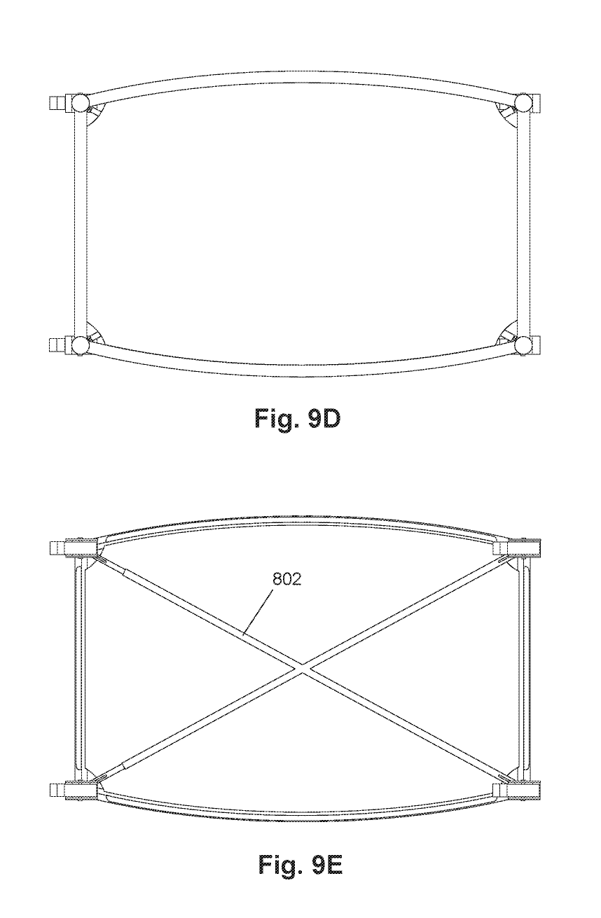

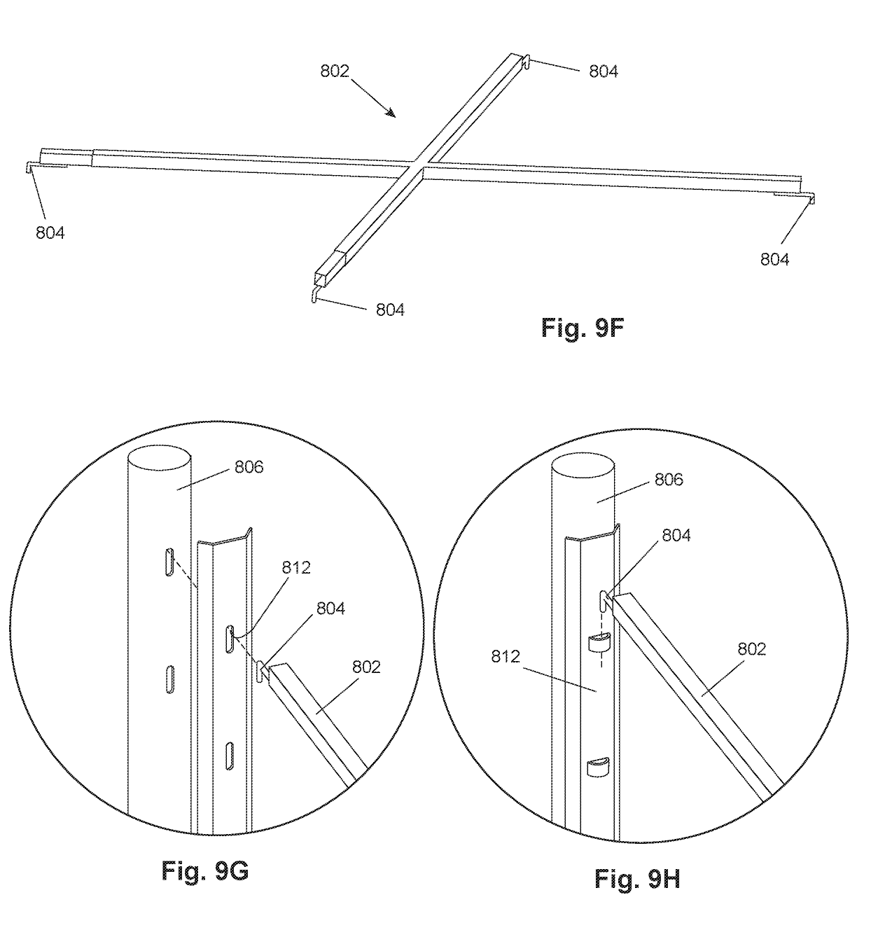

Turning to FIGS. 9A through 9H, a merchandise display bin in accordance with the present teachings illustrated and generally identified with reference character 800. A reinforcing member 802 is shown in more detail in FIG. 9F. As illustrated, the reinforcing member may generally define a cross shape. The members of the cross shape may be generally rectangular in cross section. For purposes of mounting the reinforcing member 802 to posts or uprights 806 of the display bin 800, ends of the reinforcing member 802 may carry 2 gauge wires 804 welded are otherwise suitably attached thereto.

FIGS. 9G and 9H illustrate alternative attachments of the reinforcing member 802 to the posts 806. As shown in FIG. 9G, the wires 804 may pass through slots defined in a corner trim piece 812 and engage a slot in the post 806. The post 806 may be provided with multiple slots for provide an adjustable height. In FIG. 9H, the wires 804 may engage openings stamped into the corner trim pieces 812.

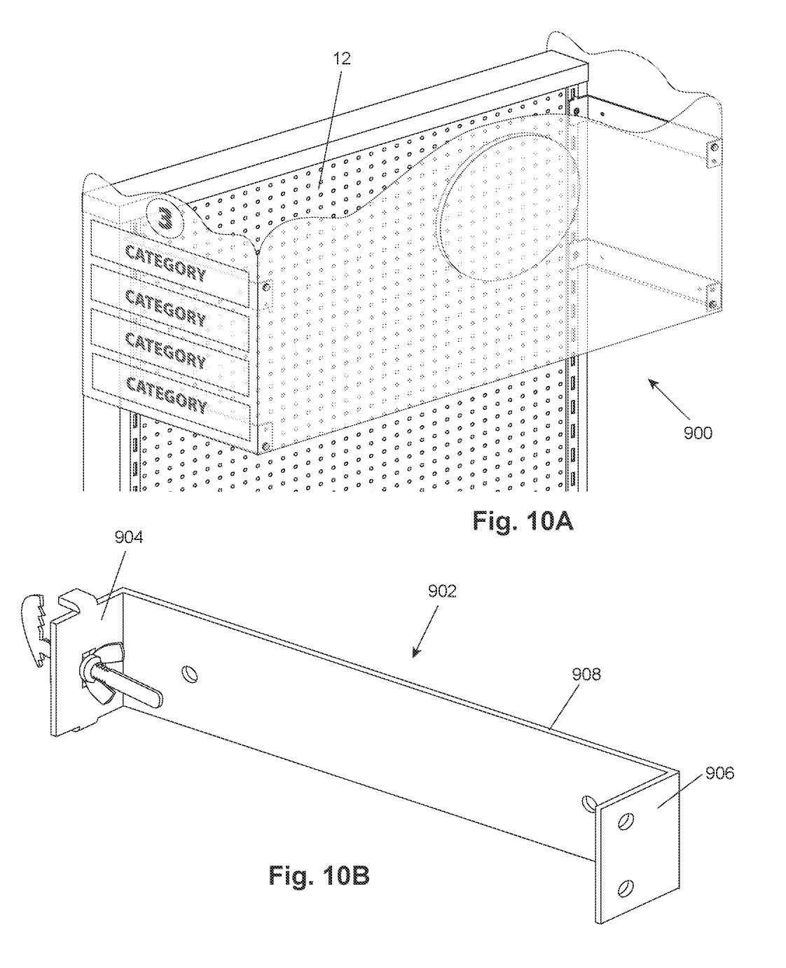

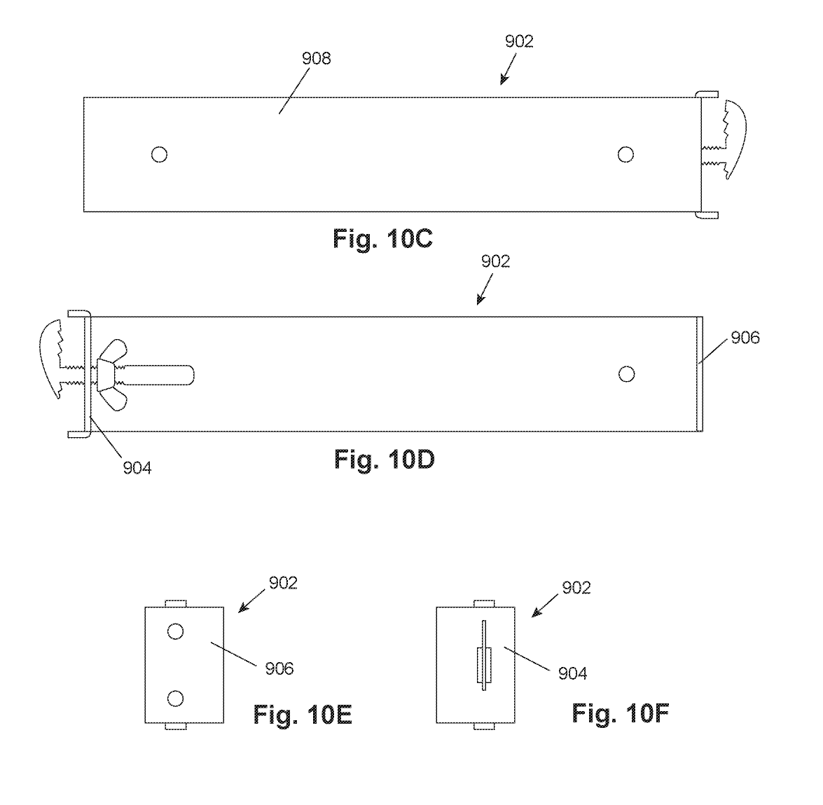

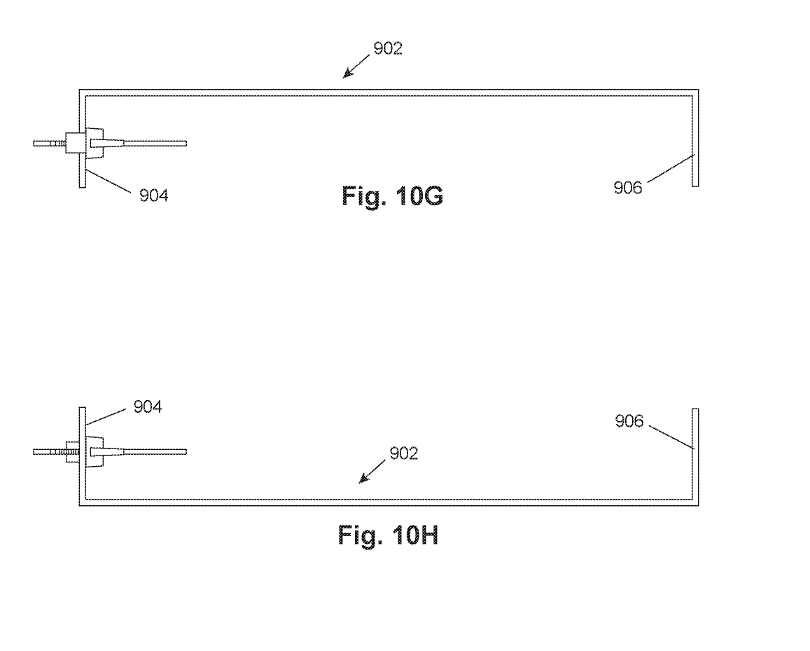

Turning to FIG. 10A, another signage system in accordance with the present teachings is illustrated and generally identified at reference character 900. The signage system is shown operatively extending from a gondola 12 and shown to generally include a plurality of extender arms 902. In the application shown in FIG. 10A, the plurality of extender arms 902 may include four extender arms 902. One of the extender arms 902 is shown in more detail in FIGS. 10B through 10H.

The extender 902 includes a first mounting portion or return 904 at a proximal end, and a second mounting portion or return 906 at a distal end and a main portion 908 extending therebetween. The mounting portion 904 is particularly adapted to engage an upright of a gondola 12 with conventional hardware.

Turning to FIG. 11, another merchandising display system in accordance with the present teachings is illustrate and generally identified at reference character 1000. The system 1000 may generally include a base 1002 and an upwardly extending display panel 1004. The base 1002 may be generally rectangular in shape with rounded corners. A plurality of casters 1006 may be carried by the base 1002. The display panel 1004 may be a pegboard. The pegboard may conventionally carry hooks or other display structure. A pair of side panels 1008 may carry graphics.

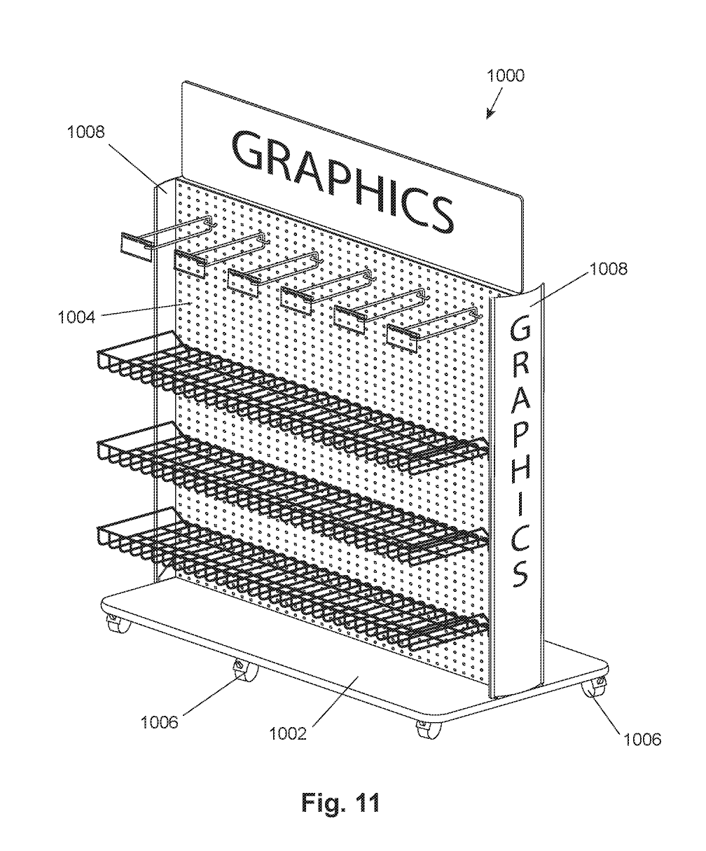

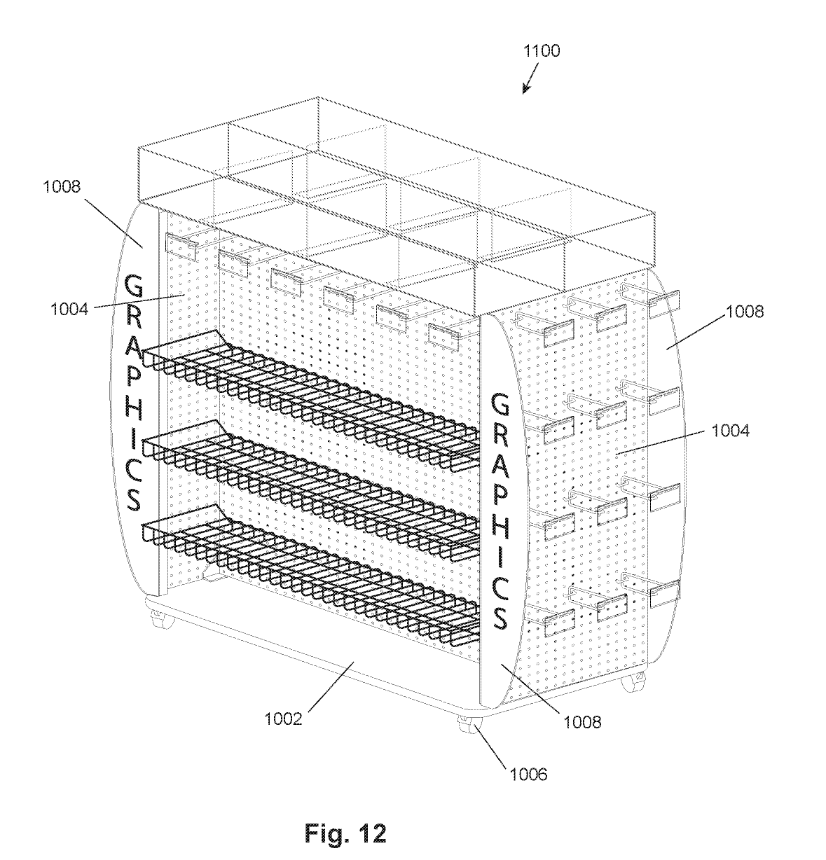

Turning to FIG. 12, another merchandising display system in accordance with the present teachings is illustrate and generally identified at reference character 1100. The system 1000 may generally include a base 1002 and a plurality of upwardly extending display panels 1004. The base 1002 may be generally rectangular in shape with rounded corners. A plurality of casters 1006 may be carried by the base 1002. The display panels 1004 may be pegboard panels. The pegboard may conventionally carry hooks or other display structure. The panels 1004 may be four in number and arranged in a rectangular shape. The system 1000 may include a plurality of side panels 1008 that may carry graphics.

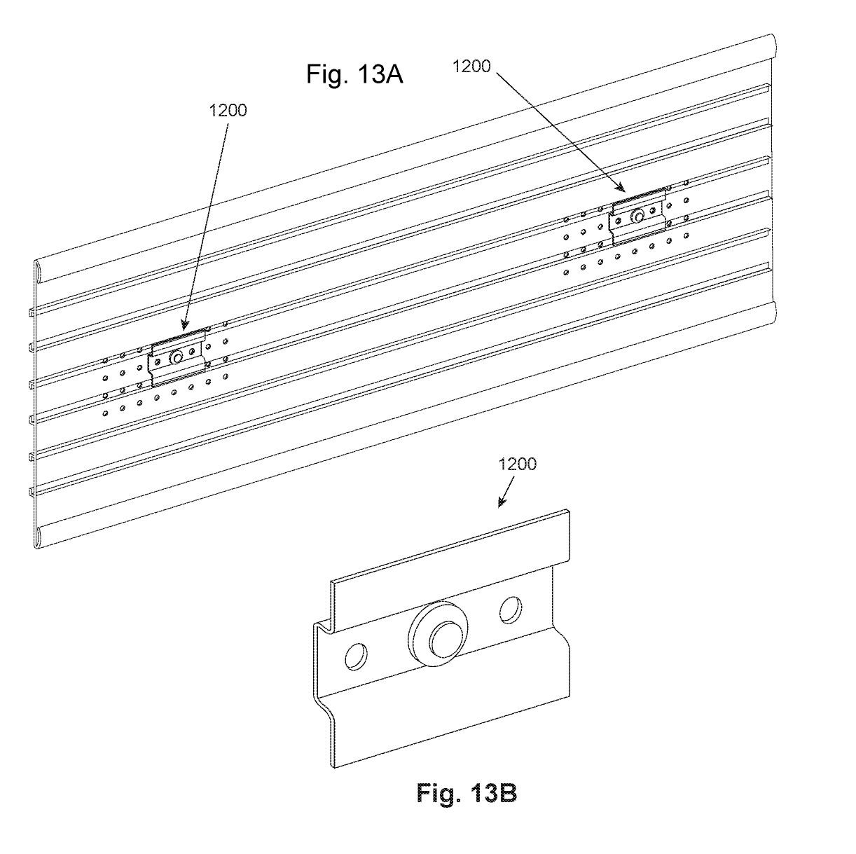

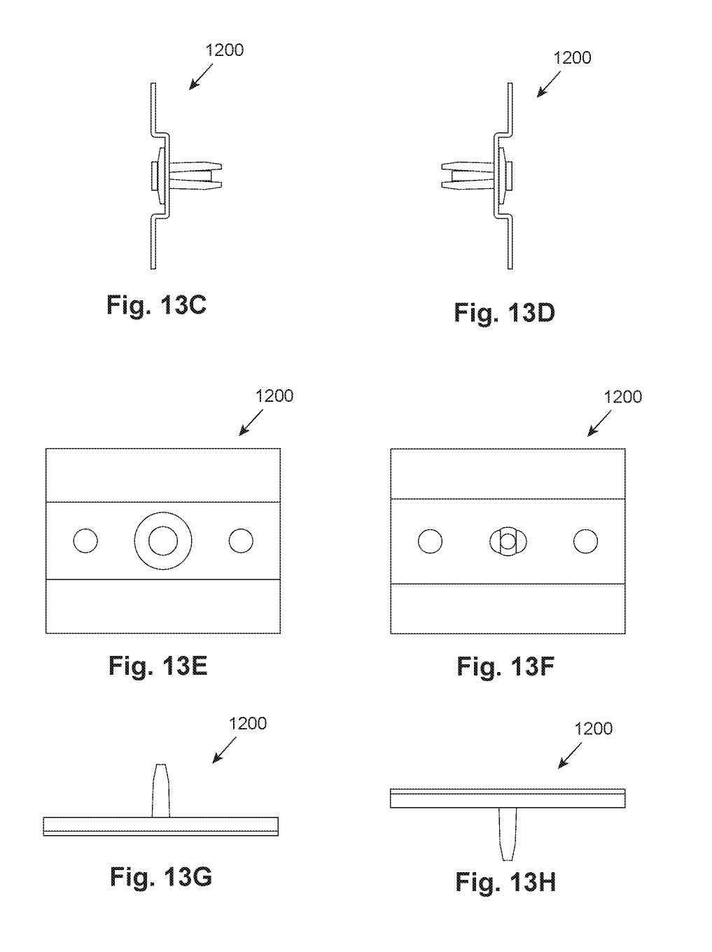

FIG. 13A is a perspective view of a sign holder operatively associated with a pair of mounting brackets in accordance with the present teachings and generally identified at reference character 1200. One of the mounting brackets is shown in more detail in FIGS. 13B-13H.

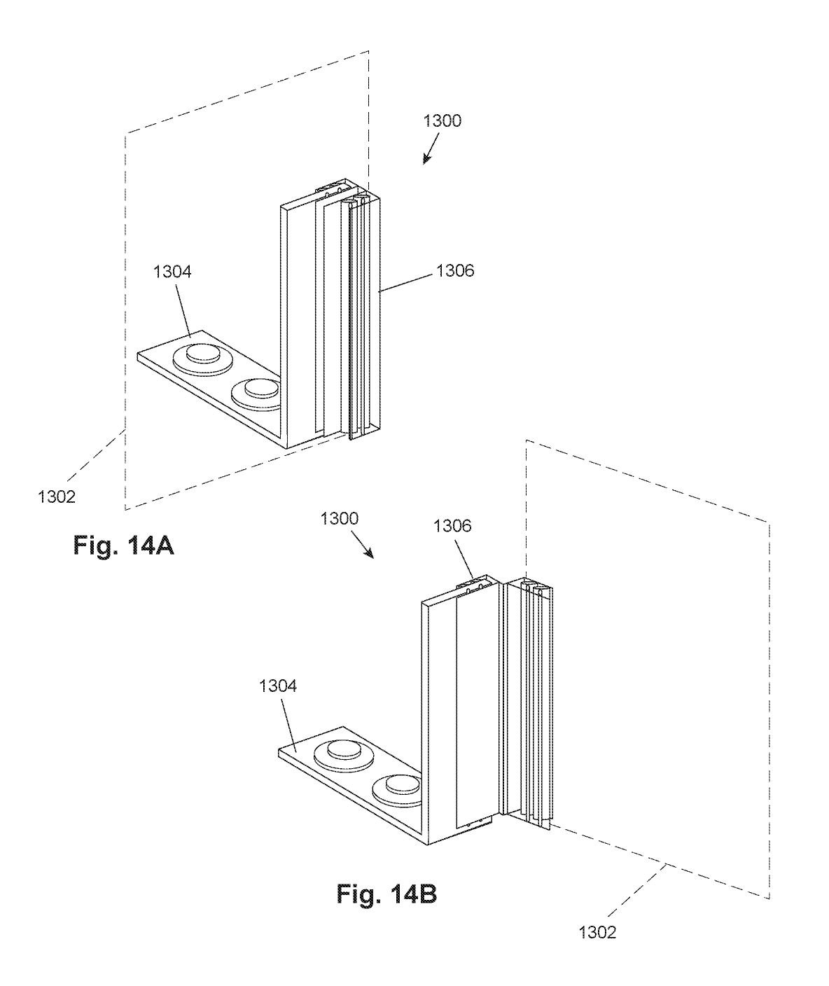

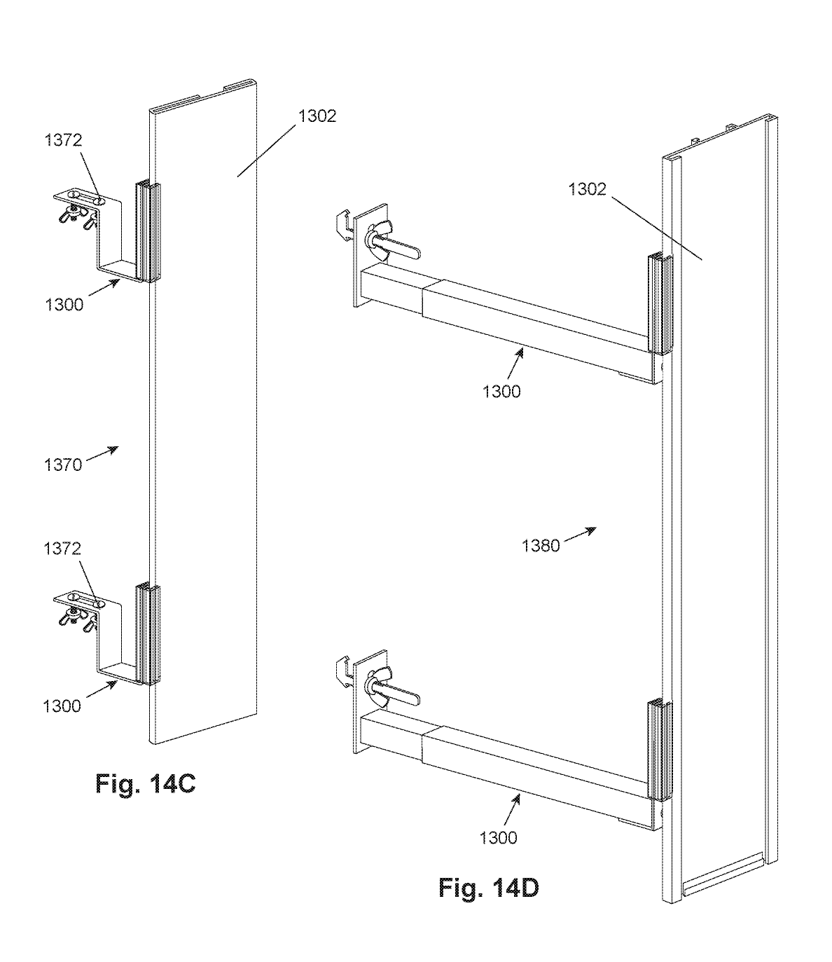

With reference now to FIGS. 14A and 14B, a flexible coupling member for a signage system in accordance with the present teachings is shown and generally identified at reference character 1300. The flexible coupling members 1300 may be used in pairs to couple a sign 1302 to a shelving system or other structure. The flexible coupling members 1300 may support the sign 1302 for movement between a first position (as shown in FIG. 14A) and a second position (as shown in FIG. 14B).

As shown, the flexible coupling members 1300 may include an L-shaped bracket 1304. A lower portion of the bracket 1304 may be secured to a gondola 12, for example, with conventional hardware. The flexible coupling members 1300 may further include a sign holder or hinged attachment member 1306. The hinged attachment member 1306 may include a first U-shaped portion defining an opening receiving an upper leg of the bracket 1304. The hinged attachment member 1306 may include a second U-shaped portion defining an opening receiving the sign 1302. The first and second U-shaped portions are hinged to one another. In the first position, the sign 1302 may be oriented generally parallel to an aisle adjacent the gondola. In the second position, the sign 1302 may be deflected to an orientation generally perpendicular to the aisle. The flexible coupling members 1300 may normally return to the first position but allow a shopper to deflect the sign to the second position for accessing merchandise behind the sign.

FIG. 14C illustrates another signage system 1370 in accordance with the present teachings. The signage system 1370 is shown to generally include a pair of flexible coupling members 1300 similar to those shown in connection with the signage system 1300. The flexible coupling members 1302 include alternate brackets 1372 for securement to a shelving system, for example. The sign holder of the signage system 1370 may be similar to the sign holder 302 described above. As above, the sign holder may rotate approximately 90 degrees from a first position (shown in FIG. 14C) to a second position (not specifically shown).

FIG. 14D illustrates yet another signage system 1380 in accordance with the present teachings. The signage system 1380 is again shown to generally include a pair of flexible coupling members 1300 similar to those shown in connection with the signage system 1300. The flexible coupling members include alternate brackets by horizontally extending arms. The horizontally extending arms may be attached to an upright of a gondola 12, for example. As above, the sign holder may rotate approximately 90 degrees from a first position (shown in FIG. 14H) to a second position (not specifically shown).

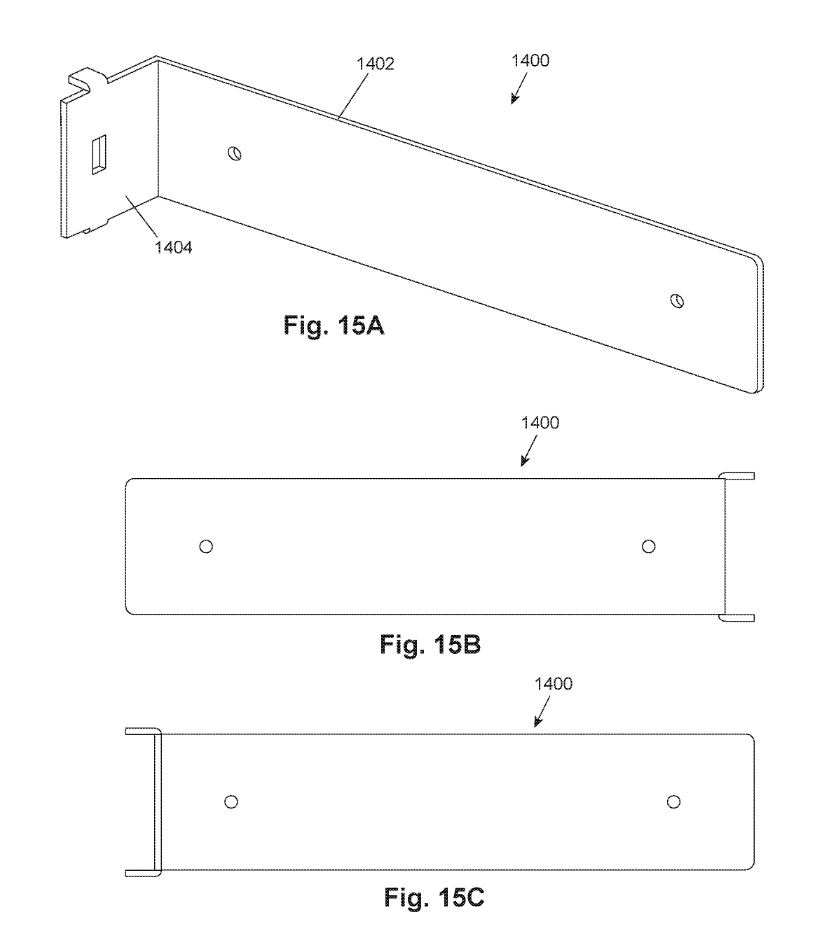

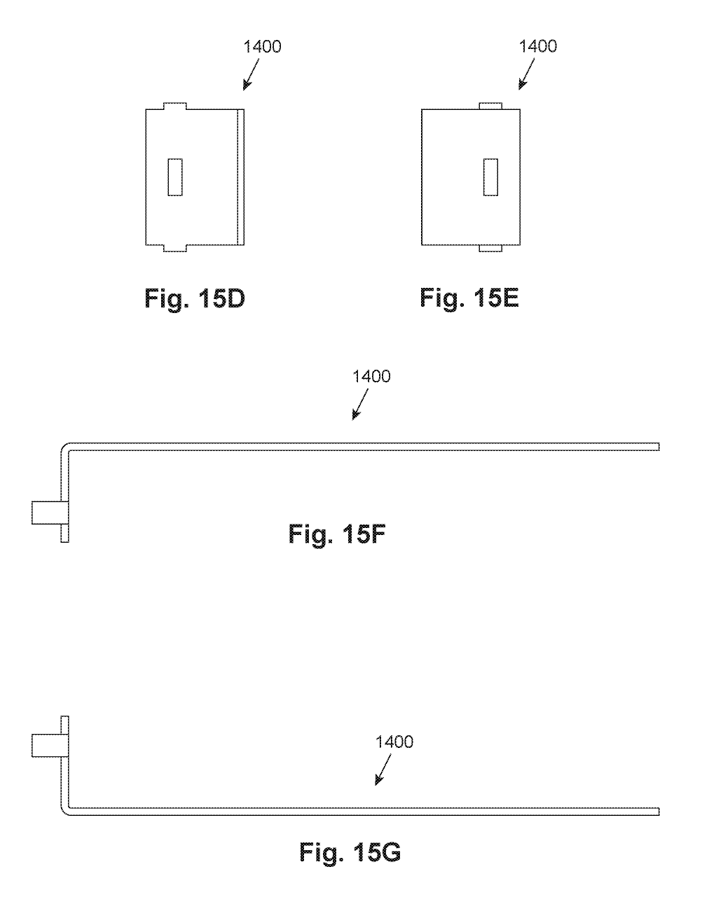

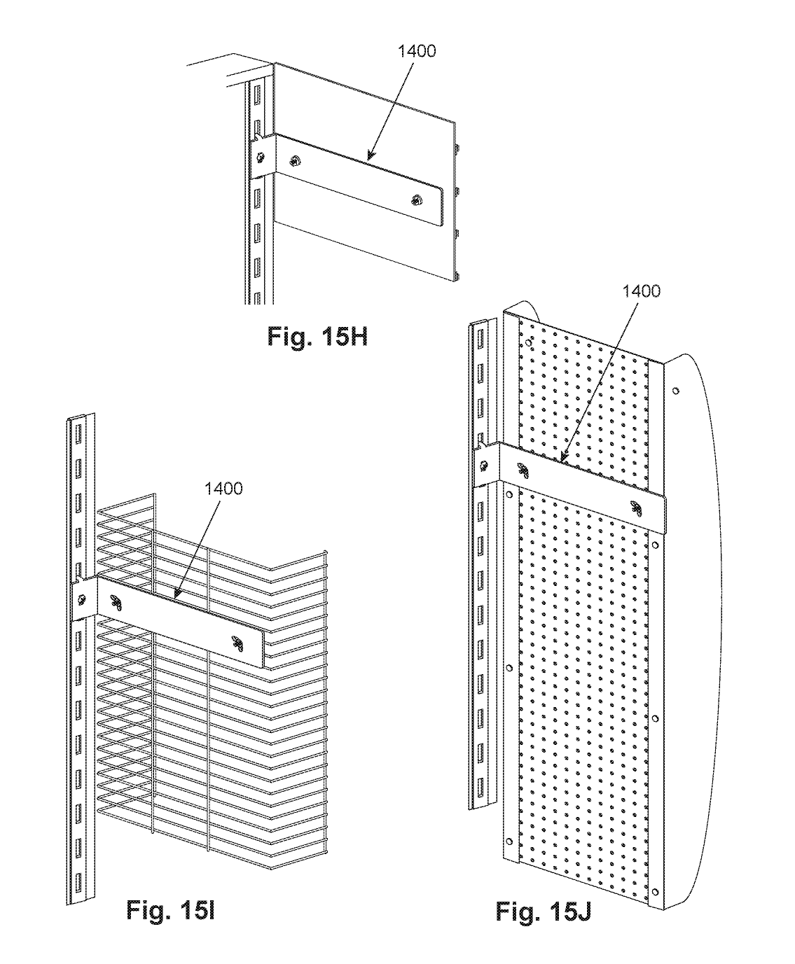

Turning to FIGS. 15A-15J, another extender arm in accordance with the present teachings is illustrated and generally shown at reference character 1400. FIG. 15H illustrates the extender arm 1400 coupling a sign holder with an upright of a gondola. FIG. 15I illustrates the extender arm coupling a sign holder with a first merchandising display. FIG. 15J illustrates the extender arm coupling a sign holder with a second merchandising display. The extender arm 1400 is generally shown to include an extender arm 1402 and a proximal end with a return portion 1404. The return portion 1404 may be particularly adapted for attachment to the gondola upright.

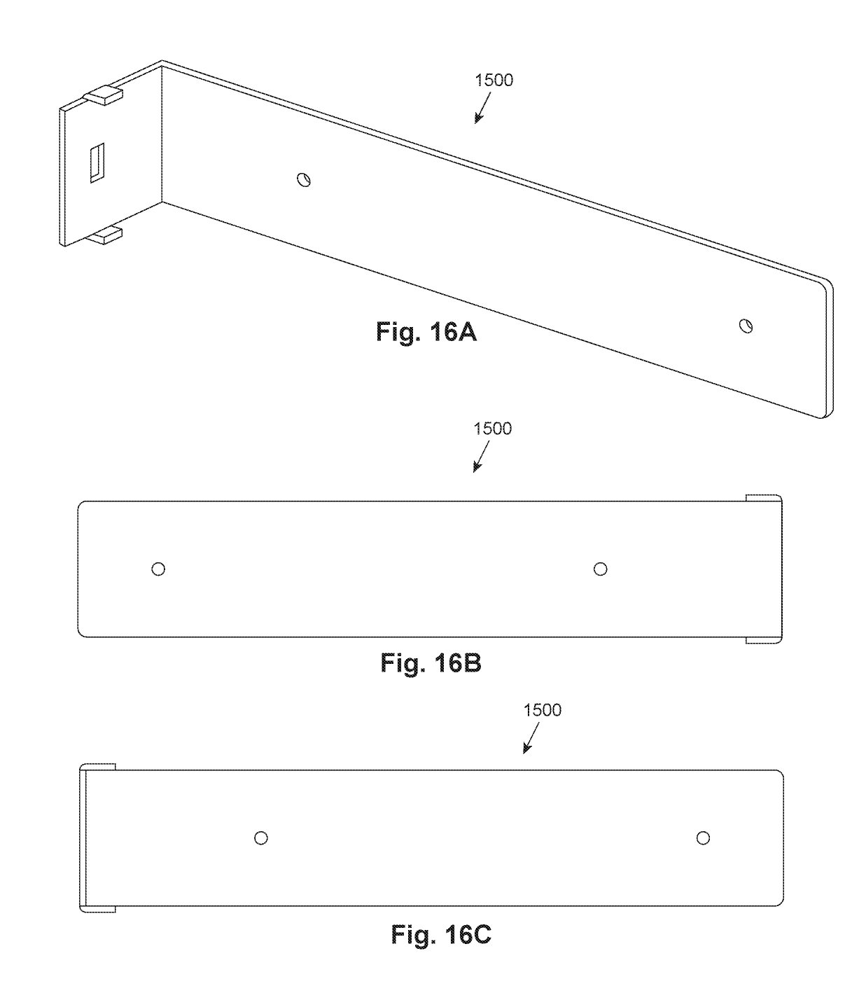

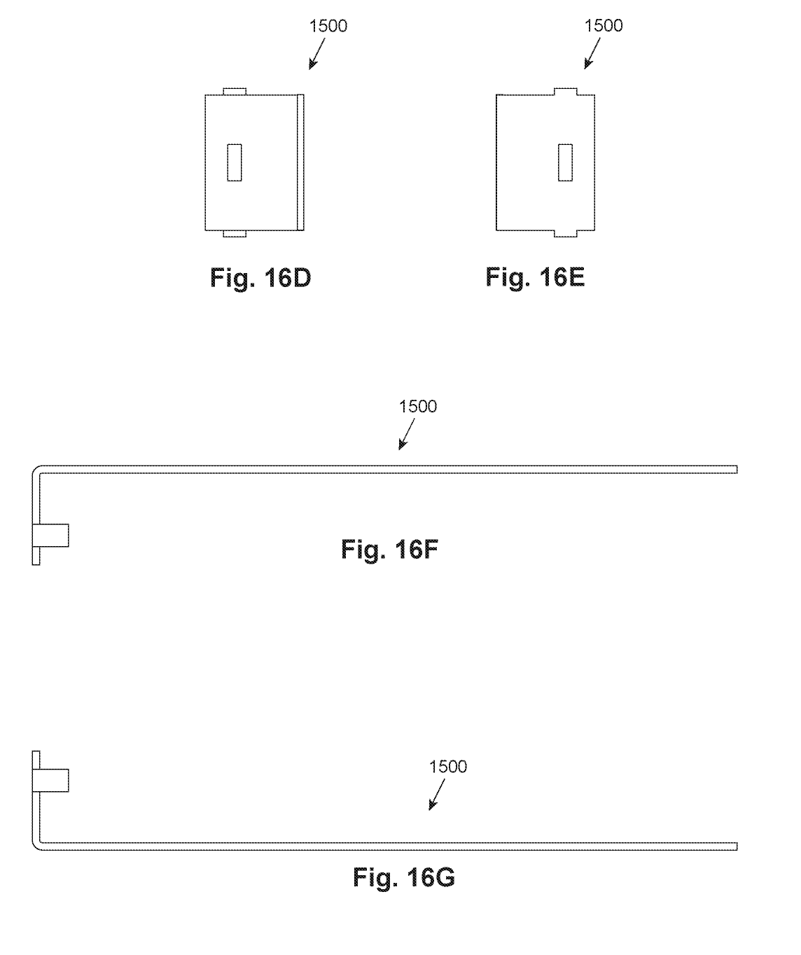

Turning to FIGS. 16A-16G, another extender arm in accordance with the present teachings is illustrated and generally shown at reference character 1500.

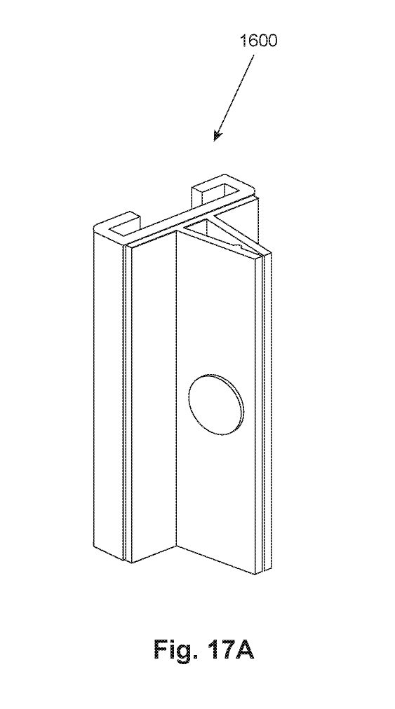

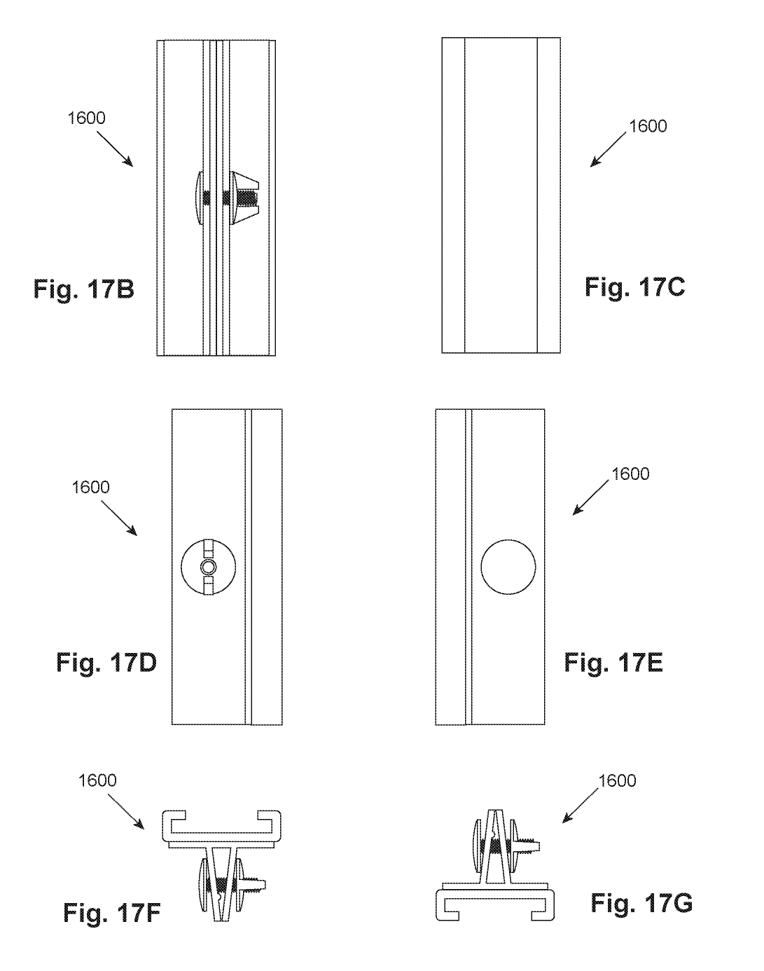

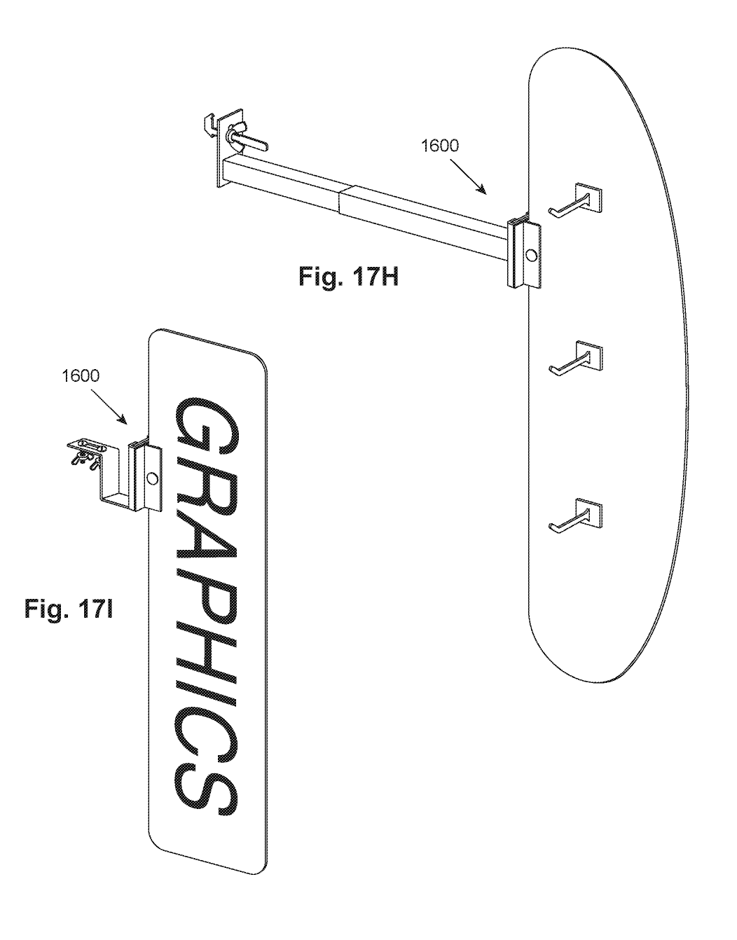

Turning to FIGS. 17A through 17I, another coupling member for a signage or merchandising display system in accordance with the present teachings is illustrated and generally identified at reference character 1600. In FIG. 17H, the coupling member is shown coupling a suspension arm with a merchandise display panel. In FIG. 17I, the coupling member is shown coupling a bracket with a sign. The coupling member 1600 may be formed to include an opening for a fastener. The coupling member 1600 may include a mounting portion and a pair of jaws extending from the mounting portion. The jaws may deflect relative to the mounting portion. A rear of the coupling member 1600 may define an opening for slidably receiving a bracket.

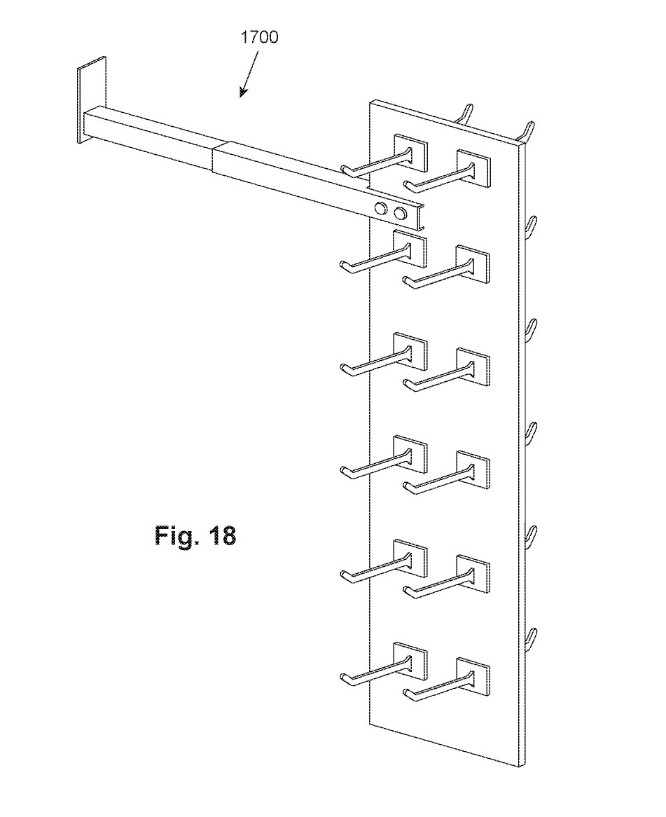

With reference to FIG. 18, another adjustable arm assembly in accordance with the present teachings is illustrated and generally identified at reference character 1700. The assembly 1700 includes a pair of arms telescopically interconnected to one another. A distal one of the arms may be attached to a mounting plate. A proximal one of the arms may be cut away or may define a slot for receiving a panel of the merchandising display.

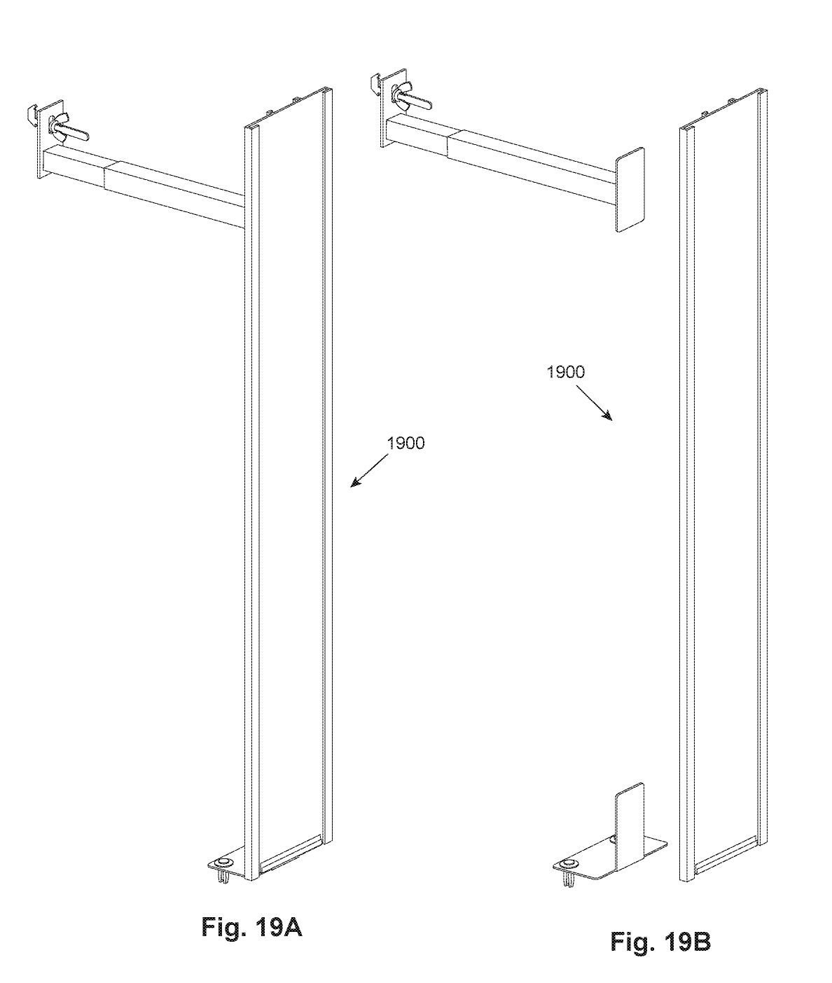

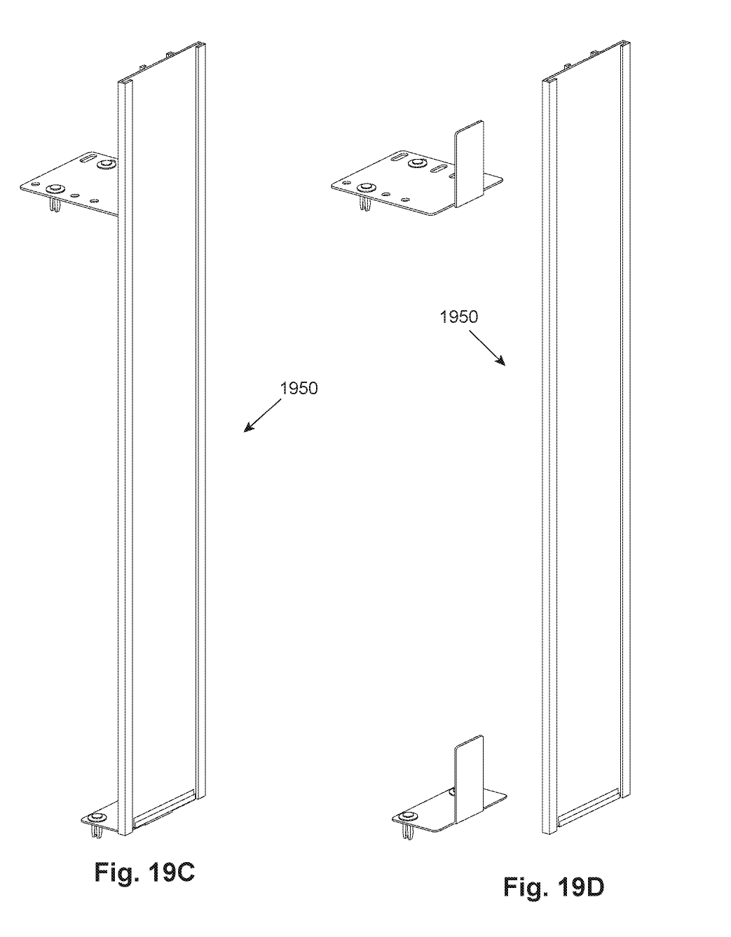

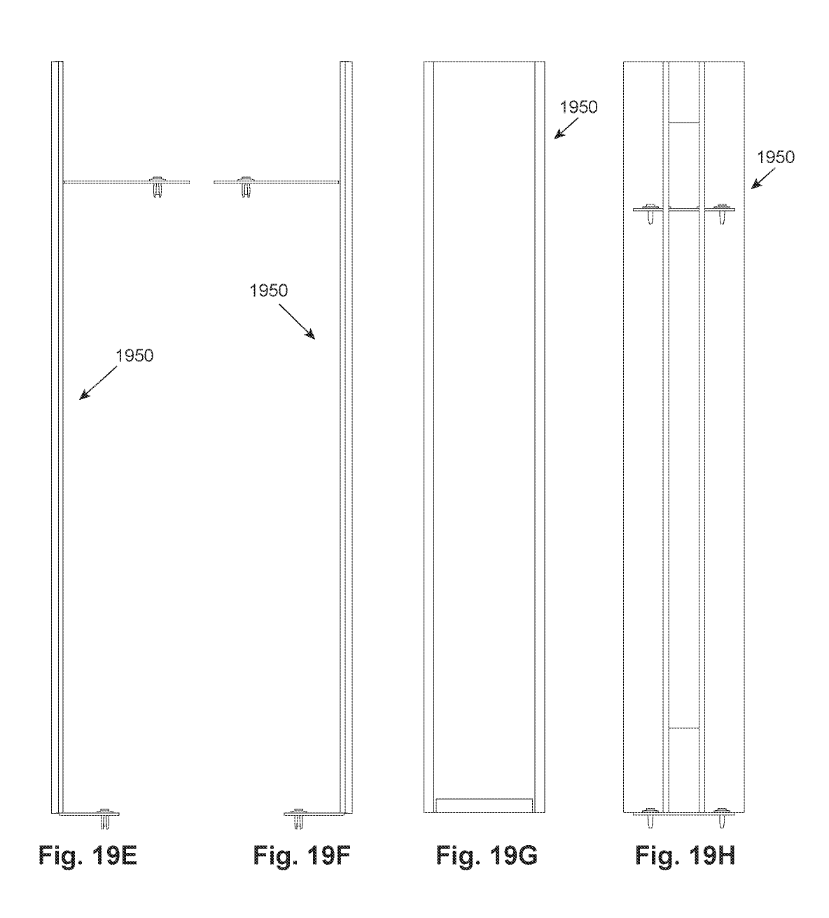

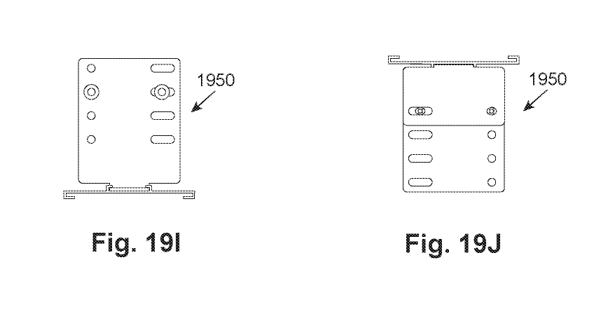

With reference to FIGS. 19A and 19B, another signage system in accordance with the present teachings is illustrated and generally identified at reference character 1900. FIG. 19B shows the signage system exploded. The signage system 1900 is illustrated to include a sign holder. The sign holder may be attached proximate an upper end to an upright of a gondola, for example, with a telescoping arm. The telescoping arm may carry a mounting plate at a distal end thereof. The mounting plate may be slidably received with a channel on a rear side of the sign holder. The sign holder may be attached proximate a lower end to a horizontal surface of a gondola, for example, with a mounting bracket. The mounting bracket may include a mounting plate slidably received with the channel on the rear side of the sign holder.

Turning to FIGS. 19C-19J, another signage system in accordance with the present teachings is illustrated and generally identified at reference character 1950. FIG. 19D shows the signage system exploded. The signage system 1950 is illustrated to include a sign holder identical to the signage system 1900 of FIGS. 19A-19B. The sign holder may be attached proximate an upper end to a shelf of a gondola, for example, with a first mounting bracket. The first mounting bracket may carry a mounting plate slidably received with the channel on the rear side of the sign holder. The sign holder may be attached proximate a lower end to a horizontal surface of a gondola, for example, with a second mounting bracket. The second mounting bracket may similarly include a mounting plate slidably received with the channel on the rear side of the sign holder. The first and second mounting brackets may be secured with rivets, for example.

While specific examples and alternatives have been described in the specification and illustrated in the drawings, it will be understood by those skilled in the art that various further changes may be made by and equivalence may be substituted for elements thereof without departing from the scope of the present teachings as defined in the claims. Furthermore, the mixing and matching of features, elements and/or functions between various examples may be expressly contemplated herein so that one skilled in the art would appreciate from the present teachings that features, elements and/or functions of one example may be incorporated into another example as appropriate, unless described otherwise above. Moreover, many modifications may be made to adapt a particular situation or material to the present teachings without departing from the essential scope thereof. Therefore, it may be intended that the present teachings not be limited to the particular examples illustrated by the drawings and described in the specification as the best mode of presently contemplated for carrying out the present teachings but that the scope of the present disclosure will include any embodiments following within the foregoing description and any appended claims.

What is claimed is:

1. An information display comprising:
a plurality of planar panels, adjacent panels coupled to one another and oriented at angles relative to one another so as to define a self-supporting structure; and
a plurality of pockets, each pocket associated with one of the panels, each pocket includes a front side, top and bottom sides, a lateral closed side and a lateral open side, the front side parallel to an associated panel, the top and bottom sides perpendicular to both the front side and the associated panel, the closed side and the open side perpendicular to the front side and the panel.

2. The information display of claim 1, wherein the plurality of planar panels and the plurality of pockets are unitarily formed.

3. The information display of claim 1, wherein the plurality of planar panels and the plurality of pockets are unitarily formed of a clear material.

4. A display assembly comprising:
a front side;
a rear side parallel to the front side;
a longitudinally extending gap at the rear side defined between first and second edges; and
a plurality of generally T-shaped slots defined at the rear side, a first arm of each slot communicating with the gap between the edges, the slots adapted to receiving a mounting arm.

5. The display assembly of claim 4, wherein the display assembly is unitarily formed of a clear material.

6. An extender arm for a merchandising display assembly, the extender arm comprising:
a planar extension arm; and
a planar return portion perpendicular to the planar extension arm, the planar return portion configured to engage an upright of a gondola.

7. The extender arm of claim 6, further comprising first and second tabs rearwardly extending from the planar return portion in a direction parallel to the planar extension portion.
